(19) United States
(12) Patent Application Publication
(10) Pub. No.: US 2024/0104384 A1
(43) Pub. Date: Mar. 28, 2024

(54) MANAGEMENT OF FEDERATED LEARNING

(71) Applicant: QUALCOMM Incorporated, San Diego, CA (US)

(72) Inventors: Rajeev Kumar, San Diego, CA (US); Gavin Bernard Horn, La Jolla, CA (US); Aziz Gholmieh, Del Mar, CA (US)

(21) Appl. No.: 17/954,824

(22) Filed: Sep. 28, 2022

(51) Int. Cl. G06N 3/08; H04W 24/02

(52) U.S. Cl. CPC G06N 3/084; H04W 24/02

(57) ABSTRACT

Methods, systems, and devices for wireless communications are described. A server (e.g., a network entity, a model repository) may select user equipment (UEs) to participate in a federated learning procedure for training a predictive model. Based on selecting the UEs, the server may determine a set of training parameters for a training configuration for the federated learning procedure. The server may transmit an indication of the training configuration to the UEs. The server may activate the federated learning procedure by transmitting an activation indication to the UEs. Each UE may locally train the predictive model according to the training configuration, and may report the model parameters to the server. The server may aggregate the reported model parameters into an updated model parameter set. The server may assign an updated parameter set identifier (PS ID) to the updated model parameter set and may inform the UEs of the updated PS ID.

### FIELD OF TECHNOLOGY

The following relates to wireless communications, including management of federated learning.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some devices in a wireless communications system may implement machine learning techniques. For example, a network entity may utilize a machine learning model that is based on a data-driven algorithm (e.g., a machine learning algorithm). UEs may perform measurements and communicate data based on the measurements to the network entity, and the network entity may use the data to train and test the machine learning model.

### SUMMARY

The described techniques relate to improved methods, systems, devices, and apparatuses that support management of federated learning. For example, the described techniques provide for user equipment (UE) to participate in a federated learning procedure according to a training configuration. A server for the federated learning procedure (which may include or be an example of a network entity, a model repository (MR), or the like) may select UEs to participate in the federated learning procedure and may select or otherwise determine a model structure (MS) and baseline parameter set (PS) for a predictive model (e.g., a machine learning model) to be trained during one or more training rounds of the federated learning procedure. Based on selecting the UEs, the server may determine a set of training parameters for a training configuration for the federated learning procedure. The server may transmit an indication of the training configuration to the UEs. In some examples, the server may activate the training round of the federated learning procedure at all of the participating UEs simultaneously, e.g., by transmitting an activation indication to the UEs. Each UE may locally train the predictive model in accordance with the training configuration and based on a dataset collected by the UE to obtain model parameters for the predictive model. The UE may report the model parameters to the server.

Additionally, the present disclosure supports techniques for aggregating, at the server, the model parameters reported by each UE into a set of updated model parameters. The server may assign a new PS ID to the set of updated parameters and may inform the UEs of the new PS ID. After receiving the new PS ID, each UE may transmit a message to the server indicating that the predictive model is ready for activation. The server may activate a subsequent training round of the federated learning procedure and each UE may locally train the predictive model based on the new PS ID. A method for wireless communications at a network node is described. The method may include selecting one or more UEs for a training procedure for a predictive model based on a trigger to activate the training procedure and transmitting an indication of a training configuration for the predictive model to the one or more UEs, the training configuration including a set of training parameters based on the one or more UEs.

An apparatus for wireless communications at a network node is described. The apparatus may include a processor, memory coupled with the processor, and instructions stored in the memory. The instructions may be executable by the processor to cause the apparatus to select one or more UEs for a training procedure for a predictive model based on a trigger to activate the training procedure and transmit an indication of a training configuration for the predictive model to the one or more UEs, the training configuration including a set of training parameters based on the one or more UEs.

Another apparatus for wireless communications at a network node is described. The apparatus may include means for selecting one or more UEs for a training procedure for a predictive model based on a trigger to activate the training procedure and means for transmitting an indication of a training configuration for the predictive model to the one or more UEs, the training configuration including a set of training parameters based on the one or more UEs.

A non-transitory computer-readable medium storing code for wireless communications at a network node is described. The code may include instructions executable by a processor to select one or more UEs for a training procedure for a predictive model based on a trigger to activate the training procedure and transmit an indication of a training configuration for the predictive model to the one or more UEs, the training configuration including a set of training parameters based on the one or more UEs.

A method for wireless communications at a server is described. The method may include selecting one or more UEs for a training procedure for a predictive model based on a trigger to activate the training procedure and transmitting an indication of a training configuration for the predictive model to the one or more UEs, the training configuration including a set of training parameters based on the one or more UEs.

An apparatus for wireless communications at a server is described. The apparatus may include a processor, memory coupled with the processor, and instructions stored in the memory. The instructions may be executable by the processor to cause the apparatus to select one or more UEs for a training procedure for a predictive model based on a trigger to activate the training procedure and transmit an indication of a training configuration for the predictive model to the one or more UEs, the training configuration including a set of training parameters based on the one or more UEs.

Another apparatus for wireless communications at a server is described. The apparatus may include means for selecting one or more UEs for a training procedure for a predictive model based on a trigger to activate the training procedure and means for transmitting an indication of a training configuration for the predictive model to the one or more UEs, the training configuration including a set of training parameters based on the one or more UEs.

A non-transitory computer-readable medium storing code for wireless communications at a server is described. The code may include instructions executable by a processor to select one or more UEs for a training procedure for a predictive model based on a trigger to activate the training procedure and transmit an indication of a training configuration for the predictive model to the one or more UEs, the training configuration including a set of training parameters based on the one or more UEs.

A method for wireless communications at a UE is described. The method may include receiving a first message indicating a training configuration for a training procedure for a predictive model, the training configuration including a set of training parameters and transmitting a second message indicating whether the UE has implemented the training configuration for the training procedure based on the set of training parameters.

An apparatus for wireless communications at a UE is described. The apparatus may include a processor, memory coupled with the processor, and instructions stored in the memory. The instructions may be executable by the processor to cause the apparatus to receive a first message indicating a training configuration for a training procedure for a predictive model, the training configuration including a set of training parameters and transmit a second message indicating whether the UE has implemented the training configuration for the training procedure based on the set of training parameters.

Another apparatus for wireless communications at a UE is described. The apparatus may include means for receiving a first message indicating a training configuration for a training procedure for a predictive model, the training configuration including a set of training parameters and means for transmitting a second message indicating whether the UE has implemented the training configuration for the training procedure based on the set of training parameters.

A non-transitory computer-readable medium storing code for wireless communications at a UE is described. The code may include instructions executable by a processor to receive a first message indicating a training configuration for a training procedure for a predictive model, the training configuration including a set of training parameters and transmit a second message indicating whether the UE has implemented the training configuration for the training procedure based on the set of training parameters.

A method for wireless communications at a server is described. The method may include transmitting, to a set of UEs, a training configuration for a training procedure associated with a predictive model, the training configuration including a first set of model parameters associated with a first PS ID, receiving, from one or more UEs of the set of UEs, one or more reports indicating one or more subsets of model parameters output from the training procedure for the predictive model at the UE, aggregating the subsets of model parameters into a second set of model parameters, assigning a second PS ID to the second set of model parameters, the second PS ID different from the first PS ID, and transmitting an indication of the second PS ID.

An apparatus for wireless communications at a server is described. The apparatus may include a processor, memory coupled with the processor, and instructions stored in the memory. The instructions may be executable by the processor to cause the apparatus to transmit, to a set of UEs, a training configuration for a training procedure associated with a predictive model, the training configuration including a first set of model parameters associated with a first PS ID, receive, from one or more UEs of the set of UEs, one or more reports indicating one or more subsets of model parameters output from the training procedure for the predictive model at the UE, aggregate the subsets of model parameters into a second set of model parameters, assign a second PS ID to the second set of model parameters, the second PS ID different from the first PS ID, and transmit an indication of the second PS ID.

Another apparatus for wireless communications at a server is described. The apparatus may include means for transmitting, to a set of UEs, a training configuration for a training procedure associated with a predictive model, the training configuration including a first set of model parameters associated with a first PS ID, means for receiving, from one or more UEs of the set of UEs, one or more reports indicating one or more subsets of model parameters output from the training procedure for the predictive model at the UE, means for aggregating the subsets of model parameters into a second set of model parameters, means for assigning a second PS ID to the second set of model parameters, the second PS ID different from the first PS ID, and means for transmitting an indication of the second PS ID.

A non-transitory computer-readable medium storing code for wireless communications at a server is described. The code may include instructions executable by a processor to transmit, to a set of UEs, a training configuration for a training procedure associated with a predictive model, the training configuration including a first set of model parameters associated with a first PS ID, receive, from one or more UEs of the set of UEs, one or more reports indicating one or more subsets of model parameters output from the training procedure for the predictive model at the UE, aggregate the subsets of model parameters into a second set of model parameters, assign a second PS ID to the second set of model parameters, the second PS ID different from the first PS ID, and transmit an indication of the second PS ID.

A method for wireless communications at a UE is described. The method may include receiving a training configuration for a training procedure associated with a predictive model, the training configuration including a first set of model parameters associated with a first PS ID, transmitting a report indicating a subset of model parameters output from the training procedure for the predictive model at the UE, and receiving an indication of a second PS ID associated with a second set of model parameters based on transmitting the report, the second PS ID different from the first PS ID.

An apparatus for wireless communications at a UE is described. The apparatus may include a processor, memory coupled with the processor, and instructions stored in the memory. The instructions may be executable by the processor to cause the apparatus to receive a training configuration for a training procedure associated with a predictive model, the training configuration including a first set of model parameters associated with a first PS ID, transmit a report indicating a subset of model parameters output from the training procedure for the predictive model at the UE, and receive an indication of a second PS ID associated with a second set of model parameters based on transmitting the report, the second PS ID different from the first PS ID.

Another apparatus for wireless communications at a UE is described. The apparatus may include means for receiving a training configuration for a training procedure associated with a predictive model, the training configuration including a first set of model parameters associated with a first PS ID, means for transmitting a report indicating a subset of model parameters output from the training procedure for the predictive model at the UE, and means for receiving an indication of a second PS ID associated with a second set of model parameters based on transmitting the report, the second PS ID different from the first PS ID.

A non-transitory computer-readable medium storing code for wireless communications at a UE is described. The code may include instructions executable by a processor to receive a training configuration for a training procedure associated with a predictive model, the training configuration including a first set of model parameters associated with a first PS ID, transmit a report indicating a subset of model parameters output from the training procedure for the predictive model at the UE, and receive an indication of a second PS ID associated with a second set of model parameters based on transmitting the report, the second PS ID different from the first PS ID.

### BRIEF DESCRIPTION OF THE DRAWINGS

FIG. 1 illustrates an example of a wireless communications system that supports management of federated learning in accordance with one or more aspects of the present disclosure.

FIG. 2 illustrates an example of a wireless communications system that supports management of federated learning in accordance with one or more aspects of the present disclosure.

FIGS. 3-5 illustrate examples of process flows that support management of federated learning in accordance with one or more aspects of the present disclosure.

FIGS. 6 and 7 show block diagrams of devices that support management of federated learning in accordance with one or more aspects of the present disclosure.

FIG. 8 shows a block diagram of a communications manager that supports management of federated learning in accordance with one or more aspects of the present disclosure.

FIG. 9 shows a diagram of a system including a device that supports management of federated learning in accordance with one or more aspects of the present disclosure.

FIGS. 10 and 11 show block diagrams of devices that support management of federated learning in accordance with one or more aspects of the present disclosure.

FIG. 12 shows a block diagram of a communications manager that supports management of federated learning in accordance with one or more aspects of the present disclosure.

FIG. 13 shows a diagram of a system including a device that supports management of federated learning in accordance with one or more aspects of the present disclosure.

FIGS. 14 through 18 show flowcharts illustrating methods that support management of federated learning in accordance with one or more aspects of the present disclosure.

### DETAILED DESCRIPTION

A wireless communications system may support a federated learning procedure to train a predictive model (e.g., a machine learning model). For a federated learning procedure, multiple clients, such as user equipment (UE), may employ a same model structure (MS) and locally train model parameters for the predictive model based on local observations or data. A server for the federated learning procedure may, in some cases, configure the MS and a baseline parameter set (PS) and may disseminate the MS and baseline PS to the clients participating in the federated learning procedure.

After performing training for the predictive model, the clients may send information for updated model parameters to the server, which compiles the information from all of the clients to determine aggregated model parameters. The server may then send the updated model parameters, or an updated predictive model, to the clients. The federated learning procedure may include multiple training rounds. The server may receive the information for the model parameters, update the machine learning model, and transmit information for an updated version of the machine learning model to the clients for another round of the federated learning procedure.

Techniques described herein support training configurations for federated learning procedures initiated by a network entity or a server, which may be an example of a model repository (MR). The network entity or server may select UEs to participate in a training round (e.g., a training procedure) of a federated learning procedure. The network entity or server may determine training parameters for the training configuration based on the selected UEs. For example, the network entity or server may select a quantity of epochs (e.g., iterations) to be performed at a UE for a given training round based on a computational capability of the UE, an estimated link capacity of the UE, or the like. Other training parameters may include a training deadline (e.g., a time at which the UE is to stop training the predictive model and report information for the model parameters), a training validity area, or the like, among other examples.

The network entity or server may indicate the training configuration to the selected UEs. In some cases, each UE may determine whether to participate in the federated learning procedure based on the training configuration (e.g., based on the training parameters). For example, a UE may determine whether the UE is capable of completing the indicated quantity of epochs within the indicated training deadline based on a computational capability of the UE. The UE may transmit a message to the network entity or server indicating whether the UE is participating in the federated learning procedure. Additionally, in some examples, the UE may transmit a message to the network entity or server indicating that the UE has implemented the training configuration, that the predictive model is ready for activation at the UE, or both. The network entity or server may simultaneously activate the federated learning procedure (e.g., the training round for the federated learning procedure) by transmitting an activation message to all of the selected UEs. Based on receiving the activation message, each UE may begin training the predictive model in accordance with the training configuration.

The UEs may report model parameters output from the predictive model after completing the training round (e.g., upon reaching the training deadline, after completing the quantity of epochs, etc.) to the network entity or server. In some examples, the server may aggregate the reported model parameters into an updated set of model parameters. The server may assign a new PS ID to the updated set of model parameters and may indicate the new PS ID to the UEs. In some examples, the server may additionally update one or more training parameters of the training configuration and may convey the updated training parameters to the UEs. Each UE may transmit a message confirming reception of the new PS ID and indicating that the predictive model is again ready for activation.

Aspects of the disclosure are initially described in the context of wireless communications systems and process flows. Aspects of the disclosure are further illustrated by and described with reference to apparatus diagrams, system diagrams, and flowcharts that relate to management of federated learning.

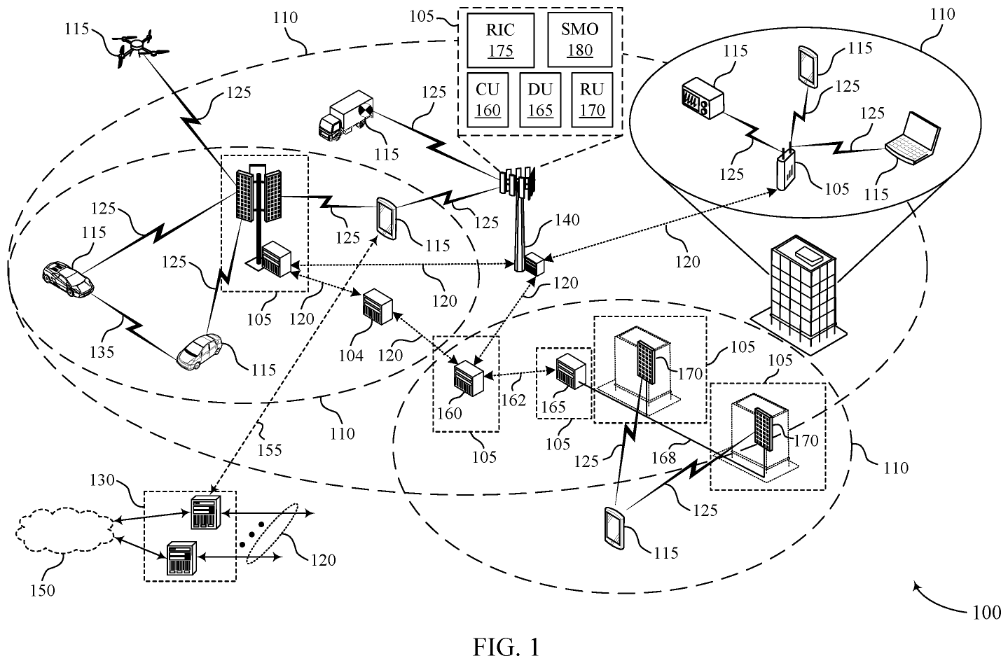

FIG. 1 illustrates an example of a wireless communications system 100 that supports management of federated learning in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof Δ UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof Δn RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support management of federated learning as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Devices in the wireless communications system 100 may implement machine learning or artificial intelligence techniques. For example, a network entity 105 may apply machine learning or artificial intelligence techniques to a data-driven algorithm that generates a set of outputs including predicted information, e.g., based on a set of inputs. This algorithm may be referred to as a predictive model, which may include or be an example of a machine learning model, an artificial intelligence model, a neural network model, or a combination thereof. The network entity 105 may collect data at the network entity 105, from other devices (e.g., UEs 115, network entities 105, or the like), or both, to provide to the predictive model as input data. The predictive model may include a model training function that prepares data (e.g., pre-processes, cleans, formats, and transforms input data) and performs training, validation, and testing of the predictive model using the prepared data. Training a predictive model may include providing training input data so that the predictive model “learns” appropriate outputs for a function or objective of the predictive model. The predictive model may be validated to confirm that appropriate outputs are generated for a set of known input data.

In some cases, other devices (e.g., network entities 105, UEs 115, or the like) in the wireless communications system 100 may additionally or alternatively utilize a predictive model, e.g., at various levels of collaboration with the network entity 105. For example, the network entity 105 may jointly perform machine learning techniques with one or more other devices. Additionally, or alternatively, the network entity 105 and the one or more other devices may each be associated with respective predictive models, but may exchange information related to machine learning (e.g., related to a predictive model) with one another. For instance, in federated learning, centralized training may be implemented using a single computing device or apparatus (e.g., a server) that can store the machine learning model and associated training data. A server may be an example of a network device (e.g., the network entity 105) or a non-network device (e.g., an MR). Federated learning may train a machine learning model, such as a global machine learning model, in a distributed manner. With federated learning, one or more clients (e.g., client devices, such as UEs 115 or other devices) may employ a same machine learning model or machine learning model structure. The machine learning model, or machine learning model structure, may be associated with a common task associated with, or performed by, the UEs 115. The UEs 115 may independently or locally train model parameters of the machine learning model based on respective observations or data collection.

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. This manner of adjusting the weights may be referred to as back propagation through the neural network. The process may continue until an achievable error rate stops decreasing or until the error rate has reached a target level. A signal may travel from input at a first layer through the multiple layers of the neural network to output at a last layer of the neural network and may traverse layers multiple times. As an example, a UE 115 may input information to a neural network, and may receive an output. The UE 115 may report information to a network node, such as a network entity 105, based on the output.

A federated learning training procedure may be associated with techniques for a network to transmit a model to a UE 115 and/or for the UE 115 to transmit updated model weights to the network. One or more machine learning models may be trained (e.g., at a server) prior to executing a training procedure. A server, a centralized unit (CU)-distributed unit (DU) (CU-DU), a model repository, or the like, may transmit a training request to a network manager based on a status of the machine learning model. The training request may be based on protocols of an operations, administration, and maintenance (OAM) entity, a network entity 105 (e.g., including a RAN-based machine learning controller), and/or a network data analytics function (NWDAF). The network manager may be a service management and orchestration (SMO)/OAM, base station, NWDAF, etc. The request may be transmitted to a mobile network. In some cases, the training may be performed at the mobile network. In other cases, a configuration may be transmitted from the mobile network to training hosts, which may correspond to network entities 105 and/or UEs 115. The UEs 115 may perform the training procedure and transmit corresponding training data to the network.

In cellular networks, for example, the training may correspond to centralized learning or distributed learning. Centralized learning may refer to training at a single network entity 105, which may include offline learning where the training may be based on pre-collected data, such as historic data, from different network entities 105 or UEs 115. Centralized learning may also include online learning where training may be based on real-time data generated or collected by network entities 105 or UEs 115. A training host may be collocated with an inference host. Distributed learning may refer to training at multiple network entities 105, UEs 115, or both. For example, distributed learning may be based on the different network entities 105 or UEs 115 transmitting data indicative of weights (e.g., updates) to a centralized MR that may aggregate the data. An example of distributed learning may include federated learning, which may be similar to centralized/online training, except that the training includes multiple training hosts (e.g., multiple UEs 115 may perform the training by sending weights to a network node (e.g., a network entity 105 or an MR that aggregates the weights). For instance, a model manager (e.g., model repository) may aggregate the weights of each training host, which may be in contrast to online learning, where one node may receive/collect the training data.

In general, a RAN machine learning architecture may include different network entities corresponding to a CU-control plane (CU-CP), a RAN-based machine learning controller, a CU-data repository (CU-DR), a CU-model repository (CU-MR), and the like, among other examples. The RAN-based machine learning controller may be used for controlling a machine learning-based procedure, such as updating an machine learning model rule for the CU-DR. The RAN-based machine learning controller may perform RAN machine learning management procedures for machine learning management at the RAN. The CU-DR may receive and store data from multiple network entities and/or provide model repository functionality. That is, the CU-DR may store and process data at the RAN. Additionally, or alternatively, the CU-MR may be used to provide the model repository. The CU-MR may store machine learning models, maintain a status of the machine learning models, perform machine learning weight aggregation based on a configuration received from the RAN-based machine learning controller, etc. The CU-CP may be used for RAN control functions, and a CU-user plane (CU-UP) may be used for RAN user plane functions.

The techniques described herein support management of federated learning procedures. In some cases, participating in a federated learning training round may be referred to as performing a federated learning procedure or a training procedure. A federated learning procedure may be controlled (e.g., initiated, configured, and activated) by an MR (e.g., a server) or a network node (e.g., an OAM, a RAN node, a network entity 115). For example, an OAM or a RAN may initiate a federated learning procedure (e.g., one or more training rounds of a federated learning procedure) based on performance or area criteria. In another example, an MR may initiate the training procedure via the OAM or RAN, for example, by transmitting an indication that training is needed (e.g., for a predictive model) to a network entity 105. Additionally, or alternatively, a network node and an MR may coordinate control of the federated learning procedure. For instance, the OAM or RAN may determine, based on the criteria, that training is needed (e.g., for a predictive model) and may indicate a request for training to an MR, which may initiate the federated learning procedure based on the request.

For example, a network entity 105 may configure a federated learning procedure for a group of UEs 115 selected by the network entity 105. The network entity 105 may configure a predictive model to be trained in the federated learning procedure by determining weights, a model structure (MS), a baseline parameter set (PS), and the like. Additionally, the network entity 105 may select a set of training parameters for a training configuration for one or more training rounds of the federated learning procedure. The set of training parameters may include an MS identifier (MS ID), a PS identifier (PS ID), a training periodicity, a quantity of epochs E, a training validity area, a training deadline, or any combination thereof. The network entity 105 may indicate the training configuration to the group of UEs 115. Each UE 115 may download the MS and PS (e.g., based on the MS ID and the PS ID).

In some examples, the network entity 105 may select one or more training parameters based on one or more UEs 115 of the group of UEs 115. For example, the network entity 105 may select a quantity of epochs (e.g., iterations) to be performed at a UE 115 for a given training round based on a computational capability of the UE 115, an estimated link capacity of the UE 115, or the like. Further, the techniques described herein support UEs 115 choosing to participate in the training round or to refrain from participating in the training round, which may be based on a flexible quantity of epochs. The network entity 105 may configure a minimum quantity of epochs as a training parameter for the training configuration. A UE 115 contributing to the federating learning session may estimate a local quantity of epochs that the UE 115 is capable of performing (e.g., based on a computational capability of the UE 115, an estimated link capacity of the UE 115, or the like) and may compare the local quantity of epochs to the minimum quantity of epochs. If the UE 115 is capable of performing the minimum quantity of epochs (e.g., if the local quantity of epochs for the UE 115 is greater than the minimum quantity of epochs), the UE 115 may determine to participate in the training round. Alternatively, if the UE 115 is unable to support the minimum quantity of epochs (e.g., if the local quantity of epochs for the UE 115 is less than the minimum quantity of epochs), the UE 115 may determine to refrain from participating in the training round. In either case, the UE 115 may indicate whether the UE 115 is participating in the training round to the network entity 105.

The network entity 105 may activate the federated learning procedure at all of the UEs 115 simultaneously by transmitting an activation message to the UEs 115. The activation message may trigger each UE 115 to begin locally training the predictive model in accordance with the training configuration. Upon completion of the training round (e.g., at the configured training deadline or after performing the configured quantity of epochs), each UE 115 may report model parameters output from the predictive model to the network entity 105.

In some cases, each UE 115 may report the model parameters to a server (e.g., an MR). The reported model parameters may be understood as updated model parameters different from the baseline PS. The server may compile the updated model parameters from the UEs 115 to generate global, or aggregated, model parameters. In some examples, this may be referred to as updating the predictive model, where the information reported from the UEs 115 is used to train the predictive model at the server and generate an updated version of the predictive model using the gathered data. The server may assign a PS ID (e.g., a new PS ID different from the PS ID associated with the baseline PS) to the set of aggregated model parameters. The server may send or forward the aggregated model parameters and the new PS ID to the UEs 115, and the UEs 115 may update the local predictive models with the updated model parameters. For example, the server may transmit an indication of the updated predictive model, such as an indication of a corresponding MS ID, to the UEs 115.

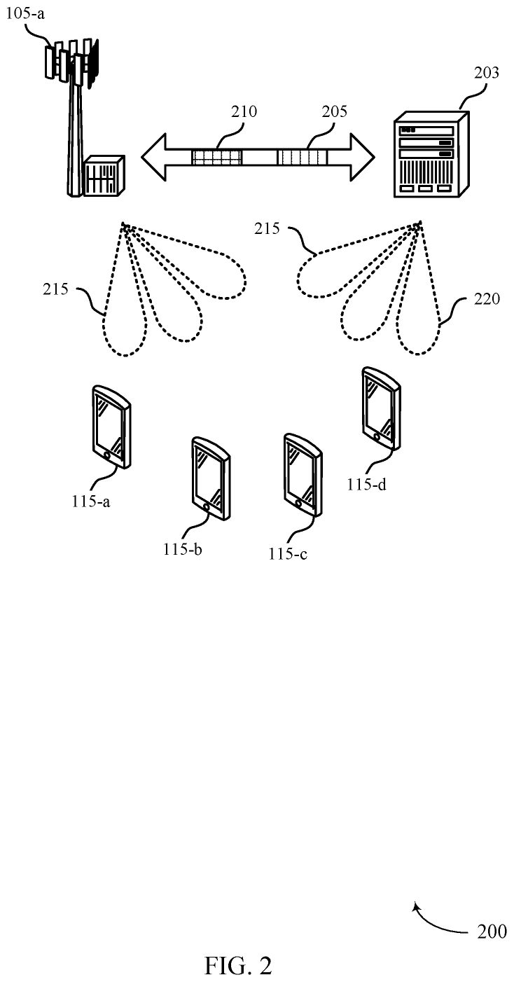

FIG. 2 illustrates an example of a wireless communications system 200 that supports management of federated learning in accordance with one or more aspects of the present disclosure. In some examples, wireless communications system 200 may implement aspects of wireless communications system 100 and may include multiple UEs 115 (e.g., a UE 115-a, a UE 115-b, a UE 115-c, and a UE 115-d), a network entity 105-a, and a server 203, which may be examples of corresponding devices as described with reference to FIG. 1. Although described as communications between UEs 115, the network entity 105-a, and the server 203, any type or quantity of devices may implement the techniques described herein. Further, the techniques described herein may be implemented by any type or quantity of devices of any wireless communications system.

The network entity 105-a, the UEs 115, and the server 203 may be examples of devices that implement data-driven machine learning techniques. Each of the network entity 105-a, the UEs 115, and the server 203 may utilize one or more predictive models (e.g., machine learning models, artificial intelligence models, neural network models, or the like) for one or more functions or objectives. The server 203 may include or be an example of an MR. The network entity 105-a may correspond to an OAM, a base station (e.g., a gNB, a RAN-based machine learning controller), a NWDAF, or the like.

The wireless communications system 200 may support a federated learning procedure to train a predictive model. For a federated learning procedure, multiple clients, such as the UEs 115, may employ a same predictive model structure to locally train model parameters for the predictive model based on observations or data. The network entity 105-a or the server 203 may select or otherwise determine a model configuration for the predictive model. The model configuration may include an MS and a baseline PS. The baseline PS may include or be associated with one or more weights to be provided (e.g., by a UE 115 during the federated learning procedure) as inputs to the predictive model for evaluation. For example, the network entity 105-a or the server 203 may configure a predictive model to be trained in the federated learning procedure by determining weights, an MS, and a baseline PS. The network entity 105-a or the server 203 may additionally determine an MS ID associated with the MS and a PS ID associated with the baseline PS. The network entity 105-a or the server 203 may configure the UEs 115 for the federated learning procedure by, for instance, indicating the MS ID and the PS ID to the UEs 115.

Each UE 115 may download the MS and PS (e.g., based on the MS ID and the PS ID) via the user plane. In some cases, the network entity 105-a or the server 203 may configure a dedicated data radio bearer for the UEs 115 to use to download the MS and PS and may transmit an indication of the data radio bearer to the UEs 115. After successfully downloading the MS and PS (e.g., via the data radio bearer) and configuring the predictive model at the UE 115, each UE 115 may transmit a configuration complete message to the network entity 105-a. The configuration complete message may be an example of a radio resource control (RRC) message (e.g., an RRCConfigurationComplete message).

The UEs 115 may train the machine learning model in accordance with the training configuration 215 received from the network entity 105-a or the server 203, where the training configuration 215 includes a set of training parameters. In some examples, the set of training parameters may include the MS ID and the baseline PS ID, such that the UEs 115 may receive the indications MS ID and the baseline PS ID as part of the training configuration 215. Based on the training, the UEs 115 may send information for updated model parameters to the network entity 105-a, the server 203, or both. The federated learning procedure may include multiple training rounds, each of which may be dynamically scheduled by the network entity 105-a. A training round may include a UE 115 receiving and implementing the training configuration 215, training the predictive model in accordance with the training configuration 215, and reporting the updated model parameters output from the training. The network entity 105-a or the server 203 may compile the information from all of the participating UEs 115 to determine global or aggregated model parameters, and may then send the updated model parameters, or an updated machine learning model, to the clients. For example, the network entity 105-a or the server 203 may receive the information for the model parameters, update the machine learning model, and transmit information for an updated version of the machine learning model to the clients for another round of the federated learning procedure.

In general, the network entity 105-a or the server 203 may determine to initiate a federated learning procedure (e.g., a training procedure, a training round for a federated learning procedure) to train a predictive model based on a trigger (e.g., a trigger condition). The trigger may include or be an example of a triggering condition, such as a communication condition, an operational condition, or the like. For instance, the network entity 105-a or the server 203 may be triggered to initiate the federated learning procedure based on performance criteria or area-specific criteria being satisfied. In some cases, the server 203 may transmit an initiation message 205 to the network entity 105-a based on the server 203 determining that a trigger condition is satisfied. The initiation message 205 may indicate that the network entity 105-a is to initiate or activate the federated learning procedure. Additionally, or alternatively, the network entity 105-a may transmit a request message 210 to the server 203 indicating a request for model training, for example, based on the trigger. That is, the network entity 105-a may determine that a trigger condition for performing a federated learning procedure is satisfied and may transmit the request message 210 to the server 203.

Initiation of the federated learning procedure may refer to determining that training is needed for a predictive model, e.g., that a federated learning procedure or a training round of the federated learning procedure is to be performed. In some examples, initiation may also include selecting UEs 115 to participate in the federated learning procedure, configuring the predictive model, determining a training configuration 215, and indicating information about the federated learning procedure (e.g., the predictive model configuration, the training configuration 215) to the participating UEs 115. Activation of the federated learning procedure may refer to activating the federated learning procedure (e.g., a training round of the federated learning procedure) at the UEs 115, e.g., by transmitting an activation message instructing the UEs to begin locally training the predictive model in accordance with the training configuration 215. In some cases, the server 203 may initiate and activate the federated learning procedure, which may be referred to as an MR-controlled federated learning procedure. In other cases, the network entity 105-a may initiate and activate the federated learning procedure, which may be referred to or understood as an OAM- or RAN-controlled federated learning procedure (e.g., the federated learning procedure is controlled by the OAM or the RAN via the network entity 105-a).

Additionally, or alternatively, the network entity 105-a and the server 203 may coordinate management of the federated learning procedure. For example, the server 203 may initiate the federated learning procedure if the server 203 determines that training is needed based on a trigger, and may transmit the initiation message 205 to the network entity 105-a instructing the network entity 105-a to begin the federated learning procedure. Based on receiving the initiation message 205, the network entity 105-a may select UEs 115 to participate in the federated learning procedure, determine an MS and a baseline PS for the predictive model, select training parameters for the training configuration 215, and indicating the MS, PS, and training configuration 215 to the UEs 115. In some examples, the network entity 105-a may request a training configuration 215, a model configuration, or both from the server 203. The request message 210 may include an example of a model provisioning request. In some cases, the network entity 105-a may transmit the request message 210 based on receiving the initiation message 205. For example, the network entity 105-a may receive the initiation message 205 indicating that the network entity 105-a is to initiate the federated learning procedure and may transmit the request message 210 to obtain a training configuration 215 for the federated learning procedure. The server 203 may, in response to the request message 210, transmit an indication of a training configuration 215 to the network entity 105-a, the UEs 115, or both. The network entity 105-a may activate the federated learning procedure after the server 203 transmits the training configuration 215.

In some examples, the network entity 105-a or the server 203 may select a subset of configured UEs 115 to participate in the federated learning procedure or in a training round of the federated learning procedure. For example, the network entity 105-a or the server 203 may configure a total quantity N of UEs 115 for the federated learning procedure by transmitting, to the N UEs 115, the MS, the baseline PS, and the training configuration 215. For each training round of the federated learning procedure, the network entity 105-a or the server 203 may select a quantity K of UEs 115 to participate, where K is less than N. In some cases, the quantity K of UEs 115 may be different for different training rounds. The network entity 105-a or the server 203 may activate the training round at the K participating UEs 115 by transmitting an activation message to the K UEs 115 (e.g., and refraining from transmitting the activation message to any non-participating UEs 115).

Additionally, the network entity 105-a or the server 203 may select the set of training parameters for the training configuration 215 for the federated learning procedure. The set of training parameters may include parameters according to which a UE 115 is to perform the training procedure and transmit a report indicating updated model parameters. For instance, the set of training parameters may include a training periodicity (e.g., a periodicity for training the predictive model), a training granularity, an MR address, a reporting granularity, a reporting periodicity (e.g., a periodicity for transmitting reports), a reporting configuration, a training validity area, a quantity of epochs E (e.g., a maximum quantity of epochs, a minimum quantity of epochs, or both), a training deadline, or any combination thereof. The set of training parameters may also include the MS ID and the PS ID.

The training validity area may indicate a geographical area for which the federated learning procedure is to be performed by a UE 115, such as all or a portion of a cell served by the network entity 105-a. That is, a UE 115 may perform the federated learning procedure if or when the UE 115 is located within the training validity area. The quantity of epochs E and the training deadline may be associated with a completed status of a training round. For example, the training deadline may indicate a time when a UE 115 is to stop (e.g., complete) performing the training procedure, a time duration within which the UE 115 is to complete the training procedure, or the like. In some cases, the training deadline may additionally include a time or time duration within which the UE 115 is to report the updated model parameters. The quantity of epochs E may indicate a quantity of iterations (e.g., weight updates) to be performed by a UE 115 during the training procedure, where an iteration includes providing a set of input data to the predictive model to obtain a set of output data. The UE 115 may stop performing the training procedure after achieving the configured quantity of epochs.

The network entity 105-a or the server 203 may indicate the training configuration 215 (e.g., the set of training parameters) to the UEs 115. For instance, the network entity 105-a or the server 203 may transmit control signaling (e.g., layer 3 (L3) control signaling), such as an RRC message, to the UEs 115 indicating the training configuration 215 and the set of training parameters. In some examples, the control signaling may include the model configuration (e.g., the MS and PS) in addition to the training configuration 215. In some cases, the network entity 105-a or the server 203 may independently configure each UE 115 by transmitting respective control signaling to individual UEs 115, while in other cases, the network entity 105-a or the server 203 may configure multiple UEs 115 (e.g., K UEs 115) with a same control signal.

In some cases, variations in capabilities or conditions of the UEs 115 may introduce constraints on the federated learning procedure. For example, each of the UEs 115 may have different computational capabilities, processing capacities, power, memory space, link capacities, or the like, such that some UEs 115 may take an extended amount of time to download the MS and PS or perform the federated learning procedure, e.g., as compared to other UEs 115. As a result, the network entity 105-a or the server 203 may receive the reports including the updated model parameter information from the UEs 115 at varying times, which may introduce latency and reduce efficiency of the federated learning procedure. Additionally, or alternatively, some UEs 115 may be unavailable or unable to participate in the federated learning procedure or in a given training round of the federated learning procedure. For example, limited power or computational capabilities may prevent a UE 115 from successfully completing the configured quantity of epochs E before the configured training deadline. In some cases, if the network entity 105-a or the server 203 receives a report from a UE 115 after a given time window associated with the federated learning procedure, the network entity 105-a or the server 203 may drop or otherwise discard the report, and the signaling used to configure and activate the federated learning procedure at the UE 115 and the computational efforts of the UE 115 may be wasted. Further, a UE 115 may be unavailable to participate in the federated learning procedure or in a given training round of the federated learning procedure if the UE 115 is in an idle or inactive mode, has a relatively poor connection to the network entity 105-a or the server 203, or travels out of a coverage area of the network entity 105-a.

Accordingly, the network entity 105-a or the server 203 may select one or more training parameters based on one or more of the UEs 115, e.g., based on computational, connectivity, and availability constraints of the UEs 115. For example, the network entity 105-a or the server 203 may select the set of training parameters based on an estimated link capacity associated with one or more of the UEs 115, a computational capability of one or more of the UEs 115, or the like. In some cases, the network entity 105-a or the server 203 may support a flexible quantity of epochs for the training configuration 215 such that each UE 115 may determine a respective local quantity of epochs to be performed at the UE 115 (e.g., based on capabilities of the UE 115). Additionally, or alternatively, participation in the federated learning procedure or in a training round of the federated learning procedure may be optional based on the constraints of a given UE 115. That is, a UE 115 receiving the training configuration 215 may determine whether to participate in the federated learning procedure based on one or more training parameters and the capabilities of the UE 115.

As a specific example, the network entity 105-a (e.g., or the server 203) may select, as a training parameter, a minimum quantity of epochs M that a given UE 115 is to complete for a training round of the federated learning procedure. The minimum quantity of epochs M may be selected based on the estimated link capacity or computational capability of one or more UEs 115. A UE 115 receiving the training configuration 215 including the minimum quantity of epochs M may estimate a quantity of local epochs F that the UE 115 is capable of completing based on a computational capability or link capacity associated with the UE 115. In some cases, the quantity of local epochs F may be based on the training deadline, e.g., may represent a quantity of epochs that the UE 115 is capable of completing within or before the training deadline. The UE 115 may compare the estimated quantity of local epochs F to the minimum quantity of epochs M to determine whether the UE 115 is capable of participating in the federated learning procedure.

If F is greater than M, the UE 115 may be able to complete the federated learning procedure according to the training configuration 215 (e.g., may be capable of performing at least M epochs within the training deadline and, in some cases, transmitting the report within the training deadline). The UE 115 may choose to participate in the federated learning procedure based on F being greater than M. Alternatively, if F is less than M, the UE 115 may be unable to complete the federated learning procedure according to the training configuration 215, and may determine to refrain from implementing the training configuration 215 and from participating in the federated learning procedure. In some examples, the UE 115 may transmit an indication of the decision (e.g., whether the UE 115 will participate in the federated learning procedure or not) to the network entity 105-a or the server 203. For instance, the UE 115 may transmit a message (e.g., an RRC message, such as an RRC configuration complete message) to the network entity 105-a or the server 203 indicating that the UE 115 has implemented the training configuration 215 or has refrained from implementing the training configuration 215. Additionally, or alternatively, the UE 115 may report the estimated quantity of local epochs F to the network entity 105-a or the server 203. The network entity 105-a or the server 203 may, in some cases, select training parameters for a subsequent training round based on F. For example, the network entity 105-a or the server 203 may select a minimum quantity of epochs for a subsequent training round to be equal to or less than F such that the UE 115 is able to participate in the subsequent training round.

Each UE 115 may configure the training procedure at the UE 115 in accordance with the training configuration 215 and the MS and baseline PS. Based on receiving (e.g., implementing) the training configuration 215, and after downloading the MS and baseline PS, each UE 115 participating in the federated learning procedure may transmit a message to the network entity 105-a or the server 203 indicating that the predictive model is ready for activation at the UE 115. The message may include or be an example of an RRC configuration complete message. In some cases, the message may additionally include the indication of whether the UE 115 is participating in the federated learning procedure, an indication of the respective estimated quantity of local epochs F, or both.

Upon receiving, from each UE 115, respective messages indicating whether the predictive model is ready for activation at the UEs 115, the network entity 105-a or the server 203 may activate the federated learning procedure (e.g., the training round) at all of the participating UEs 115 simultaneously by transmitting an activation indication to the UEs 115. The activation indication may include or be an example of layer 1 (L1) or layer 2 (L2) control signaling, such as downlink control information (DCI) or a medium access control (MAC) control element (MAC-CE). The UEs 115 may begin locally training the predictive model based on receiving the activation indication and in accordance with the training configuration 215.

A UE 115 may complete the federated learning procedure (e.g., the training round) based on the training deadline, after achieving the configured quantity of epochs (e.g., the quantity of epochs E or at least the minimum quantity of epochs M), or both. After completing the federated learning procedure, the UE 115 may transmit a report to the network entity 105-a or the server 203 indicating a set of model parameters (e.g., updated model parameters) obtained based on training the predictive model. The report may include information (e.g., weights) associated with the set of model parameters that the network entity 105-a or the server 203 may use to generate aggregated (e.g., global) model parameters. For example, the network entity 105-a or the server 203 may compile (e.g., aggregate) the updated model parameters received from the UEs 115 into a set of aggregated model parameters.

The network entity 105-a or the server 203 may assign a new PS ID 220 (e.g., a PS ID different from the PS ID associated with the baseline PS) to the set of aggregated model parameters. For example, the server 203 may select a new PS ID 220 for the set of aggregated parameters that includes the PS ID associated with the baseline PS in combination with a version tag. Alternatively, the server 203 may select a temporary PS ID as the new PS ID 220. The server 203 may send or forward the new PS ID 220 to the UEs 115. In some cases, the server 203 may transmit the new PS ID 220 to the network entity 105-a and the network entity 105-a may forward the new PS ID 220 to the UEs 115, for example, via L2 or L3 signaling (e.g., via RRC signaling, MAC-CE, DCI). The UEs 115 may download (e.g., via the user plane) or otherwise obtain the set of aggregated model parameters based on the new PS ID 220.

In some examples, the UEs 115 may update the local predictive model with the set of aggregated model parameters. Additionally, or alternatively, the aggregated model parameters may be used to train the predictive model at the network entity 105-a or the server 203 to obtain an updated version of the predictive model, and the network entity 105-a or the server 203 may transmit an indication of the updated predictive model, such as an indication of a corresponding MS ID, to the UEs 115. The UEs 115 may download (e.g., via the user plane) the updated predictive model based on the corresponding MS ID. The UEs 115 and the network entity 105-a or the server 203 may perform another round of the federated learning procedure using the set of aggregated model parameters and the updated predictive model. In some examples, the UEs 115 may continue to use the previously-indicated training configuration 215. In other examples, the network entity 105-a or the server 203 may update or otherwise modify one or more training parameters of the training configuration 215, and may transmit the updated training configuration 215 to the UEs 115.

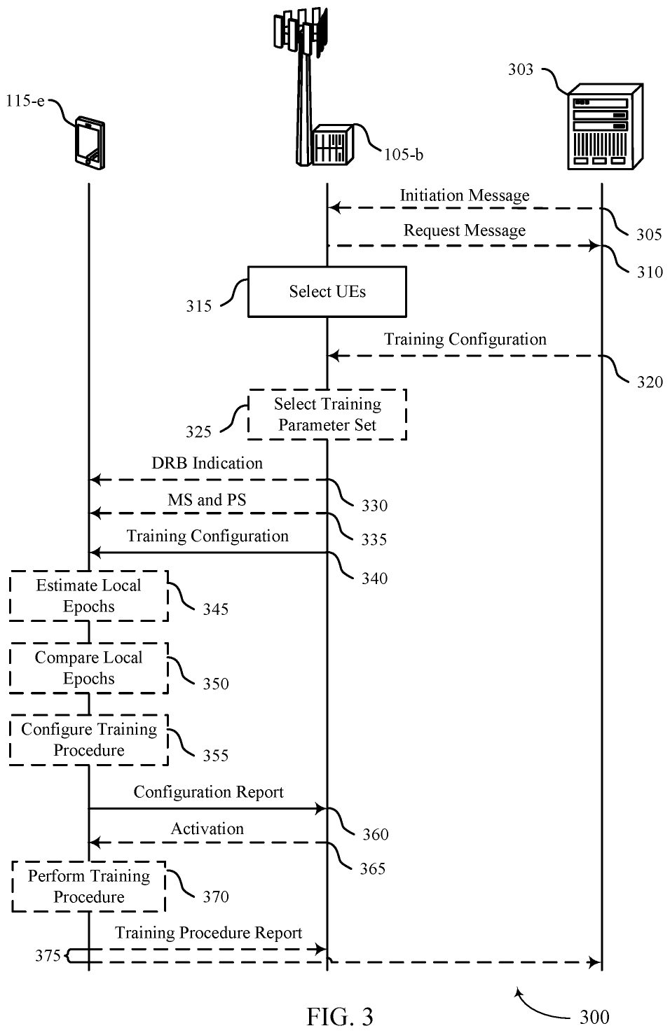

FIG. 3 illustrates an example of a process flow 300 that supports management of federated learning in accordance with one or more aspects of the present disclosure. The process flow 300 may implement or be implemented to realize aspects of the wireless communications system 100 or the wireless communications system 200. For example, the process flow 300 illustrates communication between a UE 115-e, a network entity 105-b, and a server 303, which may be examples of corresponding devices described herein.

In the following description of the process flow 300, the operations may be performed (e.g., reported or provided) in a different order than the order shown, or the operations performed by the example devices may be performed in different orders or at different times. Additionally, although the process flow 300 is described with reference to the UE 115-e, the network entity 105-c, and the server 303, any type of device or combination of devices may perform the described operations. Some operations also may be omitted from the process flow 300, or other operations may be added to the process flow 300. Further, although some operations or signaling may be shown to occur at different times for discussion purposes, these operations may actually occur at the same time or otherwise concurrently.

Process flow 300 illustrates an example of an OAM- or RAN-controlled training procedure (e.g., a federated learning procedure) for a predictive model. The training procedure may be controlled by an OAM or RAN via a network node such as the network entity 105-b. For example, although the training procedure may be initiated by the server 303 or the network entity 105-b, or the server 303 may provision a training configuration or a model configuration for the training procedure to the network entity 105-b, the network entity 105-b may control the training procedure via communications with the UE 115-e (and any additional UEs 115 participating in the training procedure). That is, the network entity 105-b may indicate the training configuration to the UE 115-e and may activate or deactivate the training procedure at the UE 115-e. Further, the network entity 105-b may collect reports (e.g., updated model parameters) from the UE 115-e in accordance with the training configuration. While the process flow 300 illustrates an training procedure with the UE 115-e, it is to be understood that additional UEs 115 not pictured may also be participating in the training procedure.

At 305, the server 303 may optionally initiate the training procedure. For example, the server 303 may transmit, and the network entity 105-b may receive, an initiation message indicating that the training procedure is to be activated by the network entity 105-b. The server 303 may transmit the initiation message to the network entity 105-b based on a trigger (e.g., based on the server 303 determining that a trigger condition is satisfied). In some examples, the network entity 105-b receiving the initiation message may be a trigger for the network entity 105-b to activate the training procedure.

At 310, the network entity 105-b may optionally transmit, and the server 303 may receive, a request message indicating a request to initiate or activate the training procedure. In some examples, the request message may include or be an example of a model provisioning request indicating a request for a model configuration for the predictive model. The model configuration may include the predictive model, an MS associated with the predictive model, a baseline PS for the predictive model, an MS ID, a baseline PS ID, or a combination thereof Δdditionally, or alternatively, the request message may indicate a request for a training configuration for the training procedure. In some examples, the server 303 may transmit the initiation message to the network entity 105-b based on receiving the request message at 310.

At 315, the network entity 105-b may select one or more UEs, including at least the UE 115-e, for the training procedure based on a trigger to activate the training procedure. In some examples, the trigger to activate the training procedure may be reception of the initiation message from the server 303, e.g., at 305.

At 320, in some examples, the server 303 may transmit, and the network entity 105-b may receive, a training configuration including a set of training parameters for the training procedure. In some cases, the server 303 may transmit the training configuration to the network entity 105-b based on receiving the request message at 310.

At 325, if the network entity 105-b does not receive a training configuration from the server 303 (e.g., at 320), the network entity 105-b may select the set of training parameters for the training configuration based on the one or more UEs (e.g., based on at least the UE 115-e). For instance, the network entity 105-b may select an MS ID associated with the predictive model, a baseline PS ID associated with the predictive model, a training validity area, a maximum quantity of epochs for the training procedure, a minimum quantity of epochs for the training procedure, a training deadline, a set of weights, a training periodicity, a reporting periodicity, a server address (e.g., an MR address), or a combination thereof. In some cases, the network entity 105-b may select one or more of the training parameters based on an estimated link capacity associated with the one or more UEs, a computational capability associated with the one or more UEs, or a combination thereof. For example, the network entity 105-b may select a minimum quantity of epochs to be performed by the one or more UEs for the training procedure based on an estimated link capacity associated with the one or more UEs, a computational capability associated with the one or more UEs, or both.

At 330, the network entity 105-b may configure a data radio bearer for the one or more UEs to use to download the MS and the baseline PS for the training procedure. The network entity 105-b may transmit, and the UE 115-e may receive, an indication of the configured data radio bearer.

At 335, in some examples, the network entity 105-b may transmit, and the UE 115-e may receive, the MS and the baseline PS. In some cases, the UE 115-e may download, via the user plane, the MS and baseline PS based on the corresponding MS ID and baseline PS ID. For example, the UE 115-e may download the MS and baseline PS via the configured data radio bearer indicated at 335.

At 340, the network entity 105-b may transmit, and the UE 115-e may receive, a message (e.g., an L3 message, such as an RRC message) indicating the training configuration that includes the set of training parameters.

At 345, the UE 115-e may optionally estimate a quantity of local epochs for the training procedure based on a computational capability of the UE 115-e, a link capacity associated with the UE 115-e or both. In some cases, the UE 115-e may estimate the quantity of local epochs based on the training configuration indicating a minimum quantity of epochs for the UE 115-e.

At 350, the UE 115-e may compare the estimated quantity of local epochs to the minimum quantity of epochs indicated in the training configuration. The UE 115-e may determine whether to participate in the training procedure and, subsequently, whether to implement the training configuration based on the comparison. For example, the UE 115-e may determine that the estimated quantity of local epochs is less than the minimum quantity of epochs, and may thus determine to refrain from implementing the training configuration (e.g., and to refrain from participating in the training procedure). Alternatively, the UE 115-e may determine that the estimated quantity of local epochs is greater than or equal to the minimum quantity of epochs, and may determine to implement the training configuration (e.g., and to participate in the training procedure).

At 355, the UE 115-e may implement the training configuration. The UE 115-e may configure the training procedure in accordance with the set of training parameters and the training configuration. For example, the UE 115-e may configure the predictive model according to the MS and the MS ID and using the baseline PS (e.g., based on the baseline PS ID). The UE 115-e may determine a quantity of epochs for the training procedure based on the indicated quantity of epochs, based on the estimated local quantity of epochs, or both. In some cases, the UE 115-e may only configure the training procedure at 355 if the UE 115-e determines to implement the training configuration and participate in the training procedure, e.g., based on the estimation and comparison at 350.

At 360, the UE 115-e may transmit a message (e.g., a configuration report) indicating whether the UE has implemented the training configuration for the training procedure, e.g., based on the estimation and comparison at 350. The message may include or be an example of an RRC complete message. In some cases, the message may additionally indicate that the UE 115-e has completed the configuration of the training procedure (e.g., at 355), that the predictive model and the training procedure are ready for activation at the UE 115-e, or both.

At 365, the network entity 105-b may transmit, and the UE 115-e may receive, a message including an activation indication for the training procedure. The message including the activation indication may be an example of L1 or L2 signaling, such as a MAC-CE or DCI. The activation indication may instruct the UE 115-e to activate (e.g., begin) the training procedure. In some cases, the network entity 105-b may transmit the activation indication based on receiving the configuration report from the UE 115-e at 360.

At 370, the UE 115-e may perform, based on the training configuration, the training procedure using the predictive model to obtain a set of one or more model parameters. For example, the UE 115-e may locally train the predictive model using the baseline PS as input data. The UE 115-e may determine updates for parameters of the predictive model based on training the predictive model using the baseline PS. In some cases, the UE 115-e may perform the training procedure at 370 based on receiving the activation indication at 365.

At 375, the UE 115-e may transmit, and the network entity 105-b may receive, a report indicating a set of model parameters obtained from the training procedure (e.g., obtained as outputs from the predictive model after completing the training procedure). The report may, in some cases, include information associated with the set of model parameters, such as weights. In some cases, the UE 115-e may additionally or alternatively transmit the report to the server 303.

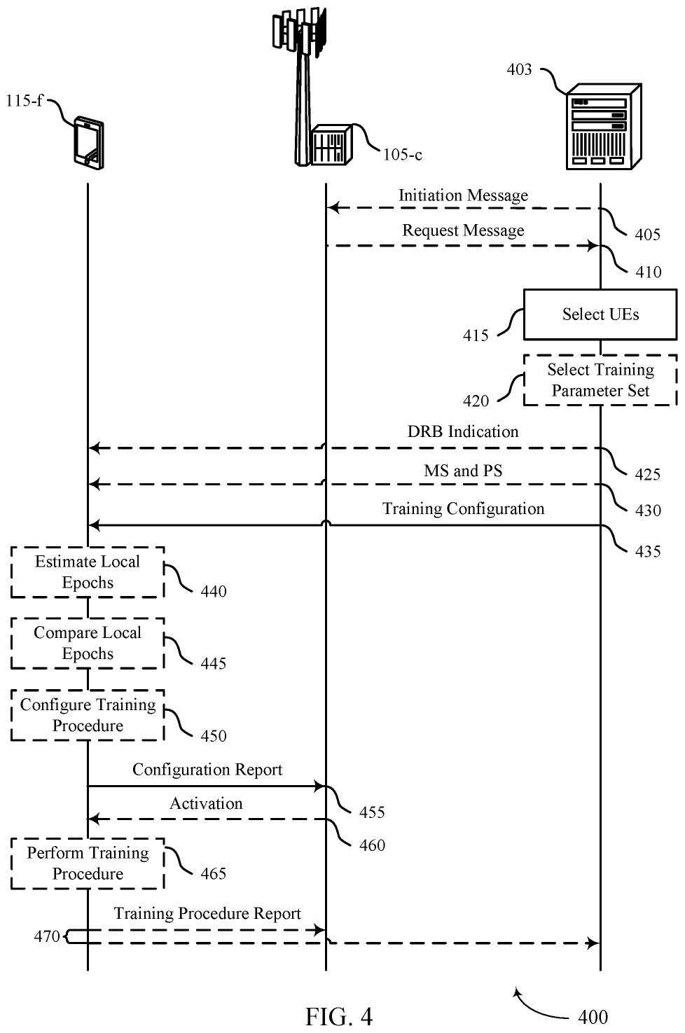

FIG. 4 illustrates an example of a process flow 400 that supports management of federated learning in accordance with one or more aspects of the present disclosure. The process flow 400 may implement or be implemented to realize aspects of the wireless communications system 100 or the wireless communications system 200. For example, the process flow 400 illustrates communication between a UE 115-f, a network entity 105-c, and a server 403, which may be examples of corresponding devices described herein.

In the following description of the process flow 400, the operations may be performed (e.g., reported or provided) in a different order than the order shown, or the operations performed by the example devices may be performed in different orders or at different times. Additionally, although the process flow 400 is described with reference to the UE 115-f, the network entity 105-c, and the server 403, any type of device or combination of devices may perform the described operations. Some operations also may be omitted from the process flow 400, or other operations may be added to the process flow 400. Further, although some operations or signaling may be shown to occur at different times for discussion purposes, these operations may actually occur at the same time or otherwise concurrently.

Process flow 400 illustrates an example of an MR-controlled training procedure (e.g., a federated learning procedure) for a predictive model. The training procedure may be controlled by the server 403, which may include or be an example of an MR. For example, although the training procedure may be initiated by the server 403 or the network entity 105-c, the server 403 may control the training procedure via communications with the UE 115-f (and any additional UEs 115 participating in the training procedure). In some cases, the server 403 may communicate directly with the UE 115-f, while in other cases, the server 403 may communicate with the UE 115-f via the network entity 105-c. While the process flow 400 illustrates an training procedure with the UE 115-f, it is to be understood that additional UEs 115 not pictured may also be participating in the training procedure.

At 405, the server 403 may optionally initiate the training procedure. For example, the server 403 may transmit, and the network entity 105-c may receive, an initiation message indicating that the training procedure is to be activated. The server 403 may transmit the initiation message to the network entity 105-c based on a trigger (e.g., based on the server 403 determining that a trigger condition is satisfied). In some examples, the network entity 105-c receiving the initiation message may be a trigger for the network entity 105-c to activate the training procedure.

At 410, the network entity 105-c may optionally transmit, and the server 403 may receive, a request message indicating a request to initiate or activate the training procedure. In some cases, the network entity 105-c may transmit the request message based on a trigger. In some examples, the request message may include or be an example of a model provisioning request indicating a request for a model configuration for the predictive model. The model configuration may include the predictive model, an MS associated with the predictive model, a baseline PS for the predictive model, an MS ID, a baseline PS ID, or a combination thereof. Additionally, or alternatively, the request message may indicate a request for a training configuration for the training procedure. In some examples, the server 403 may transmit the initiation message to the network entity 105-c based on receiving the request message at 410.

At 415, the server 403 may select one or more UEs, including at least the UE 115-f, for the training procedure based on a trigger to activate the training procedure. In some examples, the trigger to activate the training procedure may be reception of the request message from the network entity 105-c, e.g., at 405.

At 420, the server 403 may select the set of training parameters for the training configuration based on the one or more UEs (e.g., based on at least the UE 115-f). For instance, the server 403 may select an MS ID associated with the predictive model, a baseline PS ID associated with the predictive model, a training validity area, a maximum quantity of epochs for the training procedure, a minimum quantity of epochs for the training procedure, a training deadline, a set of weights, a training periodicity, a reporting periodicity, a server address (e.g., an MR address), or a combination thereof. In some cases, the server 403 may select one or more of the training parameters based on an estimated link capacity associated with the one or more UEs, a computational capability associated with the one or more UEs, or a combination thereof. For example, the server 403 may select a minimum quantity of epochs to be performed by the one or more UEs for the training procedure based on an estimated link capacity associated with the one or more UEs, a computational capability associated with the one or more UEs, or both.

At 425, the server 403 may configure a data radio bearer for the one or more UEs to use to download the MS and the baseline PS for the training procedure. The server 403 may transmit, and the UE 115-f may receive, an indication of the configured data radio bearer.

At 430, in some examples, the server 403 may transmit, and the UE 115-f may receive, the MS and the baseline PS. In some cases, the UE 115-f may download, via the user plane, the MS and baseline PS based on the corresponding MS ID and baseline PS ID. For example, the UE 115-f may download the MS and baseline PS via the configured data radio bearer indicated at 425.

At 435, the server 403 may transmit, and the UE 115-f may receive, a message (e.g., an L3 message, such as an RRC message) indicating the training configuration that includes the set of training parameters.

At 440, the UE 115-f may optionally estimate a quantity of local epochs for the training procedure based on a computational capability of the UE 115-f, a link capacity associated with the UE 115-f or both. In some cases, the UE 115-f may estimate the quantity of local epochs based on the training configuration indicating a minimum quantity of epochs for the UE 115-f.

At 445, the UE 115-f may compare the estimated quantity of local epochs to the minimum quantity of epochs indicated in the training configuration. The UE 115-f may determine whether to participate in the training procedure and, subsequently, whether to implement the training configuration based on the comparison. For example, the UE 115-f may determine that the estimated quantity of local epochs is less than the minimum quantity of epochs, and may thus determine to refrain from implementing the training configuration (e.g., and to refrain from participating in the training procedure). Alternatively, the UE 115-f may determine that the estimated quantity of local epochs is greater than or equal to the minimum quantity of epochs, and may determine to implement the training configuration (e.g., and to participate in the training procedure).

At 450, the UE 115-f may implement the training configuration. The UE 115-f may configure the training procedure in accordance with the set of training parameters and the training configuration. For example, the UE 115-f may configure the predictive model according to the MS and the MS ID and using the baseline PS (e.g., based on the baseline PS ID). The UE 115-f may determine a quantity of epochs for the training procedure based on the indicated quantity of epochs, based on the estimated local quantity of epochs, or both. In some cases, the UE 115-f may only configure the training procedure at 450 if the UE 115-f determines to implement the training configuration and participate in the training procedure, e.g., based on the estimation and comparison at 445.

At 455, the UE 115-f may transmit, and the network entity 105-c may receive, a message (e.g., a configuration report) indicating whether the UE has implemented the training configuration for the training procedure, e.g., based on the estimation and comparison at 445. The message may include or be an example of an RRC complete message. In some cases, the message may additionally indicate that the UE 115-f has completed the configuration of the training procedure (e.g., at 450), that the predictive model and the training procedure are ready for activation at the UE 115-f, or both.

At 460, the network entity 105-c may transmit, and the UE 115-f may receive, a message including an activation indication for the training procedure. may receive, a message including an activation indication for the training procedure. The message including the activation indication may be an example of L1 or L2 signaling, such as a MAC-CE or DCI. The activation indication may instruct the UE 115-f to activate (e.g., begin) the training procedure. In some cases, the network entity 105-c may transmit the activation indication based on receiving the configuration report from the UE 115-f at 455.

At 465, the UE 115-f may perform, based on the training configuration, the training procedure using the predictive model to obtain a set of one or more model parameters. For example, the UE 115-f may locally train the predictive model using the baseline PS as input data. The UE 115-f may determine updates for parameters of the predictive model based on training the predictive model using the baseline PS. In some cases, the UE 115-f may perform the training procedure at 465 based on receiving the activation indication at 460.

At 470, the UE 115-f may transmit, and the network entity 105-c, the server 403, or both, may receive, a report indicating a set of model parameters obtained from the training procedure (e.g., obtained as outputs from the predictive model after completing the training procedure). The report may, in some cases, include information associated with the set of model parameters, such as weights.

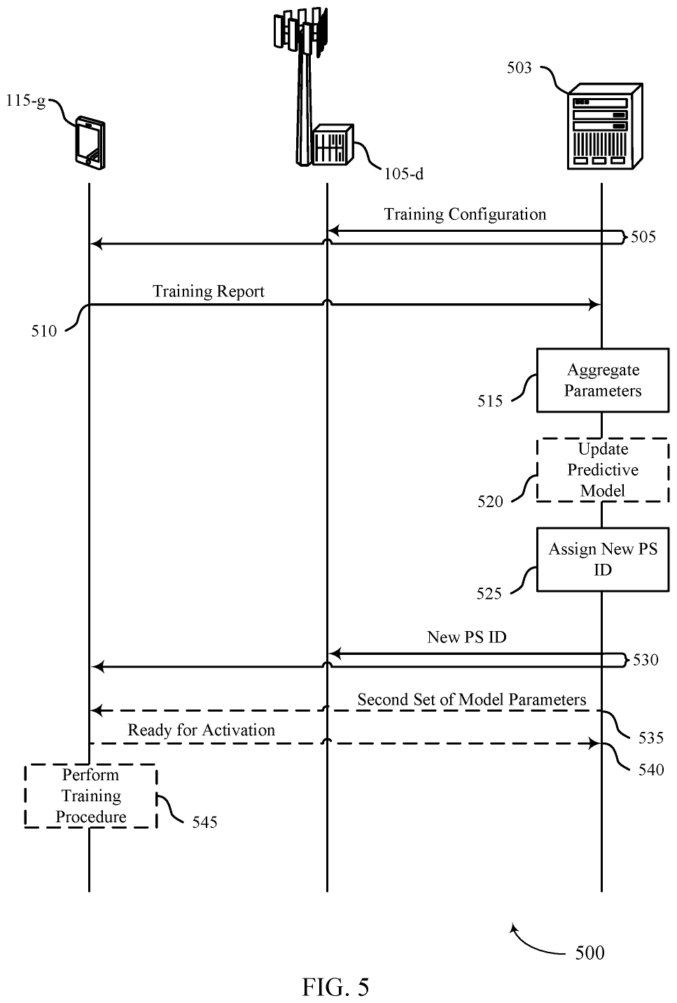

FIG. 5 illustrates an example of a process flow 500 that supports management of federated learning in accordance with one or more aspects of the present disclosure. The process flow 500 may implement or be implemented to realize aspects of the wireless communications system 100 or the wireless communications system 200. For example, the process flow 500 illustrates communication between a UE 115-g, a network entity 105-d, and a server 503, which may be examples of corresponding devices described herein. While the process flow 500 illustrates a training procedure with the UE 115-g, it is to be understood that additional UEs 115 not pictured may also be participating in the training procedure.

In the following description of the process flow 500, the operations may be performed (e.g., reported or provided) in a different order than the order shown, or the operations performed by the example devices may be performed in different orders or at different times. Additionally, although the process flow 500 is described with reference to the UE 115-g, the network entity 105-d, and the server 503, any type of device or combination of devices may perform the described operations. Some operations also may be omitted from the process flow 500, or other operations may be added to the process flow 500. Further, although some operations or signaling may be shown to occur at different times for discussion purposes, these operations may actually occur at the same time or otherwise concurrently.

At 505, the server 503 may transmit, to a set of UEs including the UE 115-g, a training configuration for a training procedure associated with a predictive model. The training configuration may include a first set of model parameters associated with a first PS ID. The training configuration may further include a set of training parameters for the training procedure, such as an MS ID associated with the predictive model, a training validity area, a maximum quantity of epochs for the training procedure, a minimum quantity of epochs for the training procedure, a training deadline, a set of weights, a training periodicity, a reporting periodicity, a server address (e.g., an MR address), or a combination thereof. In some cases, the server 503 may additionally transmit the training configuration to the network entity 105-d.

At 510, the set of UEs including the UE 115-g may transmit, and the server 503 may receive, a report indicating a subset of model parameters obtained from the training procedure (e.g., obtained as outputs from the predictive model after completing the training procedure). The report may, in some cases, include information associated with the subset of model parameters, such as weights. For example, the server 503 may receive respective reports from each UE of the set of UEs, where each report includes a respective subset of model parameters obtained by the corresponding UE.

At 515, the server 503 may aggregate the received subsets of model parameters into a second set of model parameters. The second set of model parameters may include or be an example of an updated set of model parameters for the predictive model, e.g., to be used for a subsequent round of the training procedure.

At 520, the server 503 may optionally update the predictive model, the training configuration, or both. For example, the server 503 may train the predictive model at the server 503 using the second set of model parameters to obtain an updated predictive model, which may be associated with an updated MS ID (e.g., selected by the server 503). Additionally, or alternatively, the server 503 may update or otherwise modify one or more training parameters of the training configuration (e.g., based on the second set of model parameters).

At 525, the server 503 may assign a second PS ID to the second set of model parameters. The second PS ID may be different from the first PS ID. In some examples, the second PS ID may include the first PS ID in combination with a version tag. In other examples, the second PS ID may be a temporary PS ID.

At 530, the server 503 may transmit, and the set of UEs including the UE 115-g may receive, a message indicating the second PS ID. In some examples, the UE 115-g may download the second set of model parameters via the user plane based on the second PS ID. In some cases, the server 503 may additionally transmit the second PS ID to the network entity 105-d.

At 535, the server 503 may optionally transmit, and the set of UEs including the UE 115-g may receive, a message indicating the second set of model parameters for the predictive model. The UE 115-g may update the predictive model based on (e.g., using) the second PS ID, the second set of model parameters, or both. In some cases, if the server 503 updates the training configuration (e.g., updates one or more training parameters for the training configuration), the server 503 may indicate the updated training configuration to the UE 115-g, and the UE 115-g may configure the training procedure in accordance with the updated training configuration.

At 540, based on receiving the second PS ID and, optionally, the second set of model parameters, the updated training configuration, or both, the UE 115-g may transmit, and the server 503 may receive, a message indicating that the predictive model (e.g., and the training procedure) is ready for activation at the UE 115-g.

At 545, the UE 115-g may perform the training procedure for the predictive model using the second set of model parameters and based on the second PS ID.

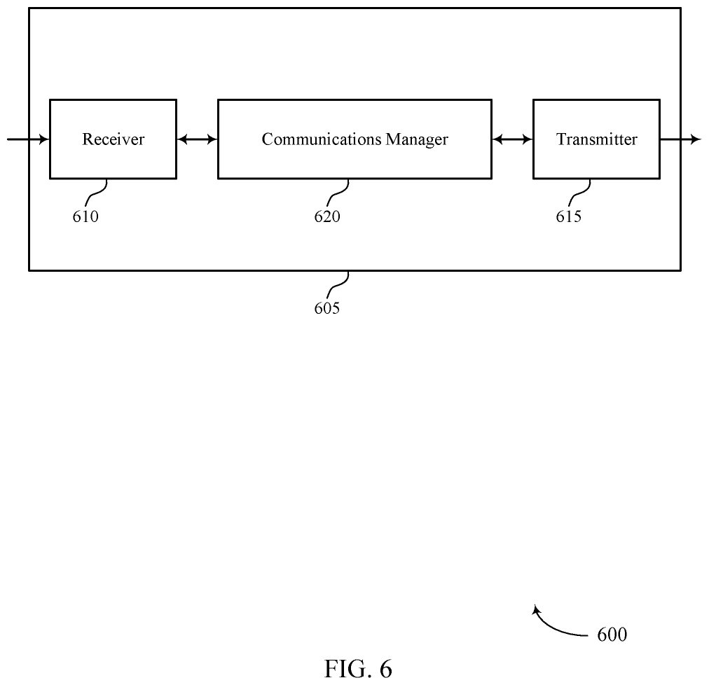

FIG. 6 shows a block diagram 600 of a device 605 that supports management of federated learning in accordance with one or more aspects of the present disclosure. The device 605 may be an example of aspects of a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of management of federated learning as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a network node in accordance with examples as disclosed herein. For example, the communications manager 620 may be configured as or otherwise support a means for selecting one or more user equipment (UEs) for a training procedure for a predictive model based on a trigger to activate the training procedure. The communications manager 620 may be configured as or otherwise support a means for transmitting an indication of a training configuration for the predictive model to the one or more UEs, the training configuration including a set of training parameters based on the one or more UEs.

Additionally, or alternatively, the communications manager 620 may support wireless communications at a server in accordance with examples as disclosed herein. For example, the communications manager 620 may be configured as or otherwise support a means for selecting one or more user equipment (UEs) for a training procedure for a predictive model based on a trigger to activate the training procedure. The communications manager 620 may be configured as or otherwise support a means for transmitting an indication of a training configuration for the predictive model to the one or more UEs, the training configuration including a set of training parameters based on the one or more UEs.

Additionally, or alternatively, the communications manager 620 may support wireless communications at a server in accordance with examples as disclosed herein. For example, the communications manager 620 may be configured as or otherwise support a means for transmitting, to a set of user equipments (UEs), a training configuration for a training procedure associated with a predictive model, the training configuration including a first set of model parameters associated with a first PS ID. The communications manager 620 may be configured as or otherwise support a means for receiving, from one or more UEs of the set of UEs, one or more reports indicating one or more subsets of model parameters output from the training procedure for the predictive model at the UE. The communications manager 620 may be configured as or otherwise support a means for aggregating the subsets of model parameters into a second set of model parameters. The communications manager 620 may be configured as or otherwise support a means for assigning a second PS ID to the second set of model parameters, the second PS ID different from the first PS ID. The communications manager 620 may be configured as or otherwise support a means for transmitting an indication of the second PS ID.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for efficient management of federated learning procedures. For example, the device 605 may select training parameters for a federated learning procedure based on capabilities of participating UEs, which may reduce processing, reduce power consumption, and provide more efficient utilization of communication resources.

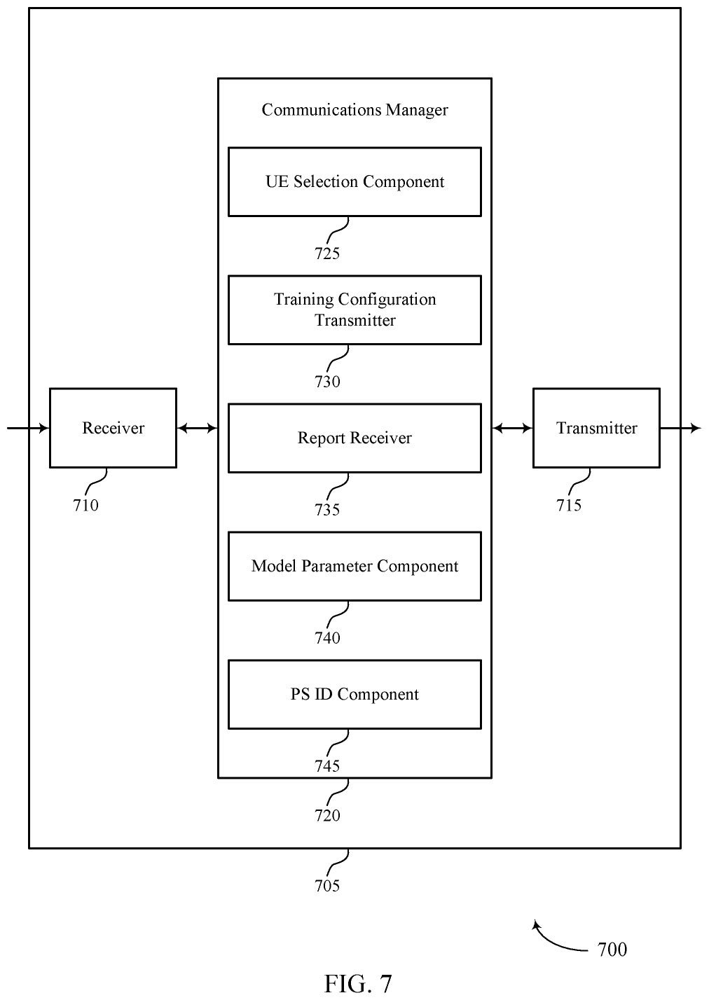

FIG. 7 shows a block diagram 700 of a device 705 that supports management of federated learning in accordance with one or more aspects of the present disclosure. The device 705 may be an example of aspects of a device 605 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of management of federated learning as described herein. For example, the communications manager 720 may include a UE selection component 725, a training configuration transmitter 730, a report receiver 735, a model parameter component 740, a PS ID component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a network node in accordance with examples as disclosed herein. The UE selection component 725 may be configured as or otherwise support a means for selecting one or more user equipment (UEs) for a training procedure for a predictive model based on a trigger to activate the training procedure. The training configuration transmitter 730 may be configured as or otherwise support a means for transmitting an indication of a training configuration for the predictive model to the one or more UEs, the training configuration including a set of training parameters based on the one or more UEs.

Additionally, or alternatively, the communications manager 720 may support wireless communications at a server in accordance with examples as disclosed herein. The UE selection component 725 may be configured as or otherwise support a means for selecting one or more user equipment (UEs) for a training procedure for a predictive model based on a trigger to activate the training procedure. The training configuration transmitter 730 may be configured as or otherwise support a means for transmitting an indication of a training configuration for the predictive model to the one or more UEs, the training configuration including a set of training parameters based on the one or more UEs.

Additionally, or alternatively, the communications manager 720 may support wireless communications at a server in accordance with examples as disclosed herein. The training configuration transmitter 730 may be configured as or otherwise support a means for transmitting, to a set of user equipments (UEs), a training configuration for a training procedure associated with a predictive model, the training configuration including a first set of model parameters associated with a first PS ID. The report receiver 735 may be configured as or otherwise support a means for receiving, from one or more UEs of the set of UEs, one or more reports indicating one or more subsets of model parameters output from the training procedure for the predictive model at the UE. The model parameter component 740 may be configured as or otherwise support a means for aggregating the subsets of model parameters into a second set of model parameters. The PS ID component 745 may be configured as or otherwise support a means for assigning a second PS ID to the second set of model parameters, the second PS ID different from the first PS ID. The PS ID component 745 may be configured as or otherwise support a means for transmitting an indication of the second PS ID.

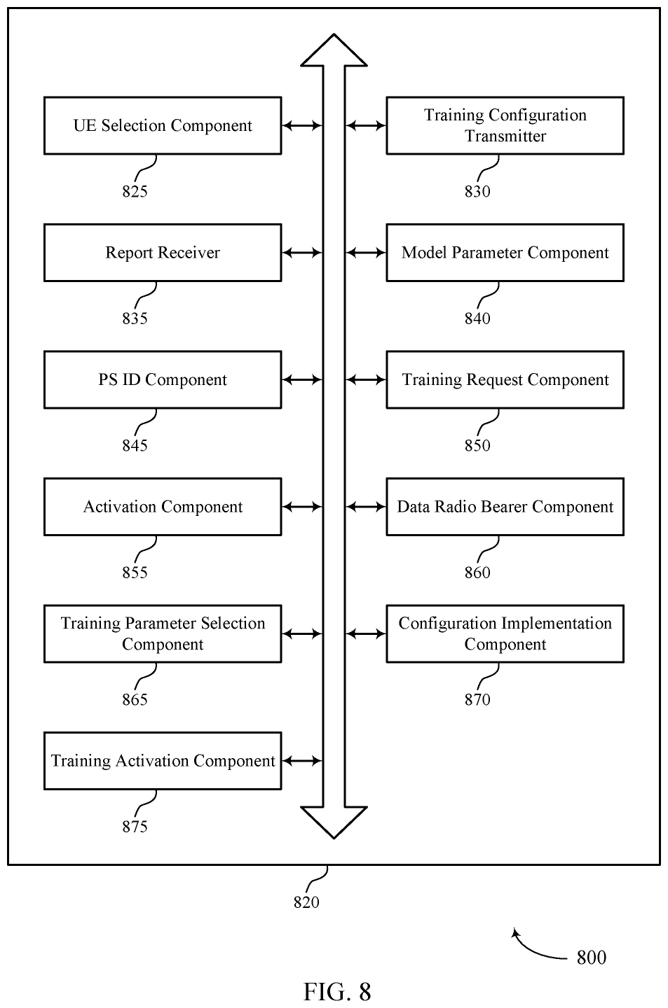

FIG. 8 shows a block diagram 800 of a communications manager 820 that supports management of federated learning in accordance with one or more aspects of the present disclosure. The communications manager 820 may be an example of aspects of a communications manager 620, a communications manager 720, or both, as described herein. The communications manager 820, or various components thereof, may be an example of means for performing various aspects of management of federated learning as described herein. For example, the communications manager 820 may include a UE selection component 825, a training configuration transmitter 830, a report receiver 835, a model parameter component 840, a PS ID component 845, a training request component 850, an activation component 855, a data radio bearer component 860, a training parameter selection component 865, a configuration implementation component 870, a training activation component 875, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications at a network node in accordance with examples as disclosed herein. The UE selection component 825 may be configured as or otherwise support a means for selecting one or more user equipment (UEs) for a training procedure for a predictive model based on a trigger to activate the training procedure. The training configuration transmitter 830 may be configured as or otherwise support a means for transmitting an indication of a training configuration for the predictive model to the one or more UEs, the training configuration including a set of training parameters based on the one or more UEs.

In some examples, the training request component 850 may be configured as or otherwise support a means for transmitting, to a server, a first message indicating a request to activate the training procedure. In some examples, the activation component 855 may be configured as or otherwise support a means for receiving, from the server, a second message indicating activation of the training procedure.

In some examples, the activation component 855 may be configured as or otherwise support a means for receiving, from a server, a first message indicating that the network node is to activate the training procedure, where the first message includes the trigger.

In some examples, the data radio bearer component 860 may be configured as or otherwise support a means for transmitting, to the one or more UEs, an indication of a data radio bearer configured for downloading a model structure and a baseline parameter set associated with the predictive model.

In some examples, the training parameter selection component 865 may be configured as or otherwise support a means for selecting the set of training parameters for the training configuration based on an estimated link capacity associated with the one or more UEs, a computational capability associated with the one or more UEs, or a combination thereof.

In some examples, the set of training parameters includes a minimum quantity of epochs for the training procedure to be performed at a UE of the one or more UEs. In some examples, the set of training parameters includes a MS ID associated with the predictive model, a baseline PS ID associated with the predictive model, a training validity area, a maximum quantity of epochs for the training procedure, a minimum quantity of epochs for the training procedure, a training deadline, a set of weights, a periodicity, a server address, or a combination thereof.

In some examples, the configuration implementation component 870 may be configured as or otherwise support a means for receiving, from at least one UE of the one or more UEs, a message indicating that the at least one UE has implemented the training configuration. In some examples, the configuration implementation component 870 may be configured as or otherwise support a means for receiving, from at least one UE of the one or more UEs, a message indicating that the at least one UE has refrained from implementing the training configuration.

In some examples, the activation component 855 may be configured as or otherwise support a means for receiving, from at least one UE of the one or more UEs, a message indicating that the predictive model is ready for activation at the at least one UE. In some examples, the activation component 855 may be configured as or otherwise support a means for transmitting, to the one or more UEs, a message including an indication to activate the training procedure at the one or more UEs.

Additionally, or alternatively, the communications manager 820 may support wireless communications at a server in accordance with examples as disclosed herein. In some examples, the UE selection component 825 may be configured as or otherwise support a means for selecting one or more user equipment (UEs) for a training procedure for a predictive model based on a trigger to activate the training procedure. In some examples, the training configuration transmitter 830 may be configured as or otherwise support a means for transmitting an indication of a training configuration for the predictive model to the one or more UEs, the training configuration including a set of training parameters based on the one or more UEs.

In some examples, the training request component 850 may be configured as or otherwise support a means for receiving, from a network node, a message indicating a request to activate the training procedure, where the indication of the training configuration is transmitted based on receiving the message.

In some examples, the training activation component 875 may be configured as or otherwise support a means for transmitting, to a network node, a message indicating that the network node is to activate the training procedure, where the message includes the trigger.

In some examples, the data radio bearer component 860 may be configured as or otherwise support a means for transmitting, to the one or more UEs, an indication of a data radio bearer configured for downloading a model structure and a baseline parameter set associated with the predictive model.

In some examples, the training parameter selection component 865 may be configured as or otherwise support a means for selecting the set of training parameters for the training configuration based on an estimated link capacity associated with the one or more UEs, a computational capability associated with the one or more UEs, or a combination thereof. In some examples, the set of training parameters includes a minimum quantity of epochs for the training procedure to be performed at a UE of the one or more UEs.

In some examples, the set of training parameters includes a MS ID associated with the predictive model, a baseline PS ID associated with the predictive model, a training validity area, a maximum quantity of epochs for the training procedure, a minimum quantity of epochs for the training procedure, a training deadline, a set of weights, a periodicity, a server address, or a combination thereof.

Additionally, or alternatively, the communications manager 820 may support wireless communications at a server in accordance with examples as disclosed herein. In some examples, the training configuration transmitter 830 may be configured as or otherwise support a means for transmitting, to a set of user equipments (UEs), a training configuration for a training procedure associated with a predictive model, the training configuration including a first set of model parameters associated with a first PS ID. The report receiver 835 may be configured as or otherwise support a means for receiving, from one or more UEs of the set of UEs, one or more reports indicating one or more subsets of model parameters output from the training procedure for the predictive model at the UE. The model parameter component 840 may be configured as or otherwise support a means for aggregating the subsets of model parameters into a second set of model parameters. The PS ID component 845 may be configured as or otherwise support a means for assigning a second PS ID to the second set of model parameters, the second PS ID different from the first PS ID. In some examples, the PS ID component 845 may be configured as or otherwise support a means for transmitting an indication of the second PS ID.

In some examples, the activation component 855 may be configured as or otherwise support a means for receiving, from at least one UE of the set of UEs, a message indicating that the predictive model is ready for activation at the UE based on transmitting the indication.

In some examples, the model parameter component 840 may be configured as or otherwise support a means for transmitting, to the set of UEs, a message indicating the second set of model parameters for the predictive model, the second set of model parameters including an updated set of model parameters for the predictive model. In some examples, to support transmitting the indication, the PS ID component 845 may be configured as or otherwise support a means for transmitting the indication to a network node, to the set of UEs, or both. In some examples, the second PS ID includes a temporary PS ID or a combination of the first PS ID and a version tag.

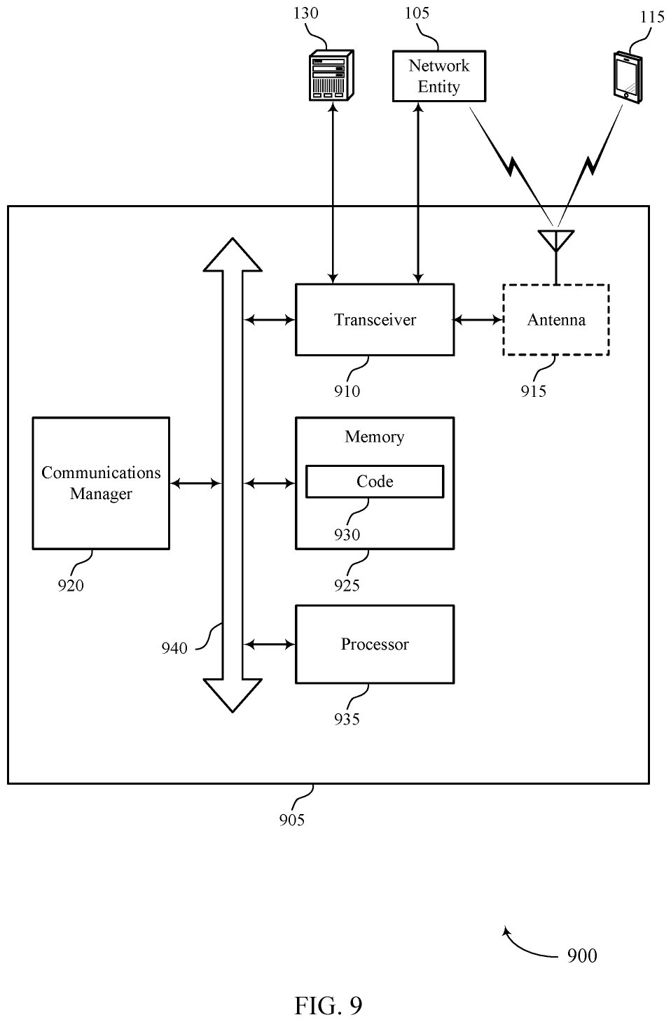

FIG. 9 shows a diagram of a system 900 including a device 905 that supports management of federated learning in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or memory components (for example, the processor 935, or the memory 925, or both), may be included in a chip or chip assembly that is installed in the device 905. In some examples, the transceiver may be operable to support communications via one or more communications links (e.g., a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting management of federated learning). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905. The processor 935 may be any one or more suitable processors capable of executing scripts or instructions of one or more software programs stored in the device 905 (such as within the memory 925). In some implementations, the processor 935 may be a component of a processing system. A processing system may generally refer to a system or series of machines or components that receives inputs and processes the inputs to produce a set of outputs (which may be passed to other systems or components of, for example, the device 905). For example, a processing system of the device 905 may refer to a system including the various other components or subcomponents of the device 905, such as the processor 935, or the transceiver 910, or the communications manager 920, or other components or combinations of components of the device 905. The processing system of the device 905 may interface with other components of the device 905, and may process information received from other components (such as inputs or signals) or output information to other components. For example, a chip or modem of the device 905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 905 may transmit information output from the chip or modem. Additionally, or alternatively, in some implementations, the one or more interfaces may refer to an interface between the processing system of the chip or modem and a receiver, such that the device 905 may obtain information or signal inputs, and the information may be passed to the processing system. A person having ordinary skill in the art will readily recognize that a first interface also may obtain information or signal inputs, and a second interface also may output information or signal outputs.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communications at a network node in accordance with examples as disclosed herein. For example, the communications manager 920 may be configured as or otherwise support a means for selecting one or more user equipment (UEs) for a training procedure for a predictive model based on a trigger to activate the training procedure. The communications manager 920 may be configured as or otherwise support a means for transmitting an indication of a training configuration for the predictive model to the one or more UEs, the training configuration including a set of training parameters based on the one or more UEs.

Additionally, or alternatively, the communications manager 920 may support wireless communications at a server in accordance with examples as disclosed herein. For example, the communications manager 920 may be configured as or otherwise support a means for selecting one or more user equipment (UEs) for a training procedure for a predictive model based on a trigger to activate the training procedure. The communications manager 920 may be configured as or otherwise support a means for transmitting an indication of a training configuration for the predictive model to the one or more UEs, the training configuration including a set of training parameters based on the one or more UEs.

Additionally, or alternatively, the communications manager 920 may support wireless communications at a server in accordance with examples as disclosed herein. For example, the communications manager 920 may be configured as or otherwise support a means for transmitting, to a set of user equipments (UEs), a training configuration for a training procedure associated with a predictive model, the training configuration including a first set of model parameters associated with a first PS ID. The communications manager 920 may be configured as or otherwise support a means for receiving, from one or more UEs of the set of UEs, one or more reports indicating one or more subsets of model parameters output from the training procedure for the predictive model at the UE. The communications manager 920 may be configured as or otherwise support a means for aggregating the subsets of model parameters into a second set of model parameters. The communications manager 920 may be configured as or otherwise support a means for assigning a second PS ID to the second set of model parameters, the second PS ID different from the first PS ID. The communications manager 920 may be configured as or otherwise support a means for transmitting an indication of the second PS ID.

By including or configuring the communications manager 920 in accordance with examples as described herein, the device 905 may support techniques for efficient management of federated learning procedures. For example, the device 905 may select training parameters for a federated learning procedure based on capabilities of participating UEs, which may reduce processing, reduce power consumption, and provide more efficient utilization of communication resources.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, the processor 935, the memory 925, the code 930, or any combination thereof. For example, the code 930 may include instructions executable by the processor 935 to cause the device 905 to perform various aspects of management of federated learning as described herein, or the processor 935 and the memory 925 may be otherwise configured to perform or support such operations.

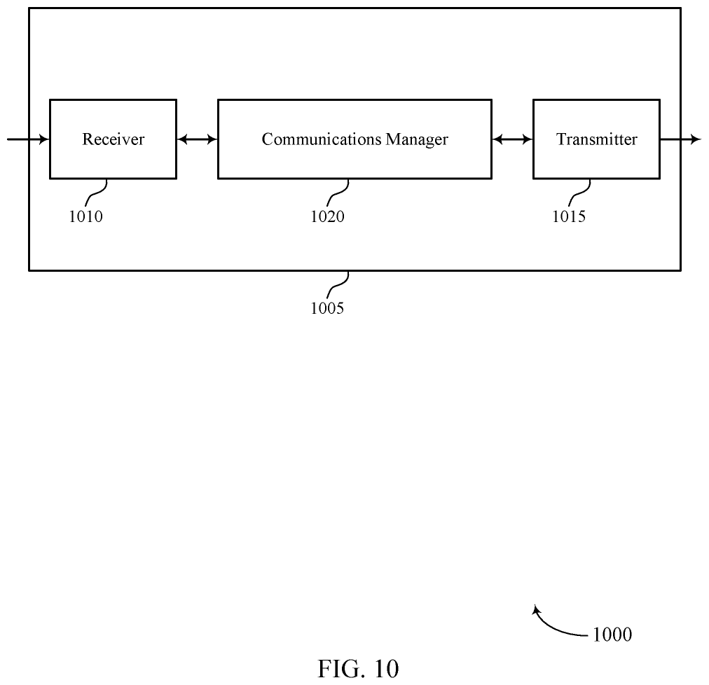

FIG. 10 shows a block diagram 1000 of a device 1005 that supports management of federated learning in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to management of federated learning). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to management of federated learning). In some examples, the transmitter 1015 may be co-located with a receiver 1010 in a transceiver unit. The transmitter 1015 may utilize a single antenna or a set of multiple antennas.

The communications manager 1020, the receiver 1010, the transmitter 1015, or various combinations thereof or various components thereof may be examples of means for performing various aspects of management of federated learning as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. For example, the communications manager 1020 may be configured as or otherwise support a means for receiving a first message indicating a training configuration for a training procedure for a predictive model, the training configuration including a set of training parameters. The communications manager 1020 may be configured as or otherwise support a means for transmitting a second message indicating whether the UE has implemented the training configuration for the training procedure based on the set of training parameters.

Additionally, or alternatively, the communications manager 1020 may support wireless communications at a UE in accordance with examples as disclosed herein. For example, the communications manager 1020 may be configured as or otherwise support a means for receiving a training configuration for a training procedure associated with a predictive model, the training configuration including a first set of model parameters associated with a first PS ID. The communications manager 1020 may be configured as or otherwise support a means for transmitting a report indicating a subset of model parameters output from the training procedure for the predictive model at the UE. The communications manager 1020 may be configured as or otherwise support a means for receiving an indication of a second PS ID associated with a second set of model parameters based on transmitting the report, the second PS ID different from the first PS ID.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for efficient management of federated learning procedures. For example, the device 1005 may determine whether to participate in the FL procedure based on a capability of the device 1005, which may reduce processing, reduce power consumption, and improve efficient utilization of communication resources.

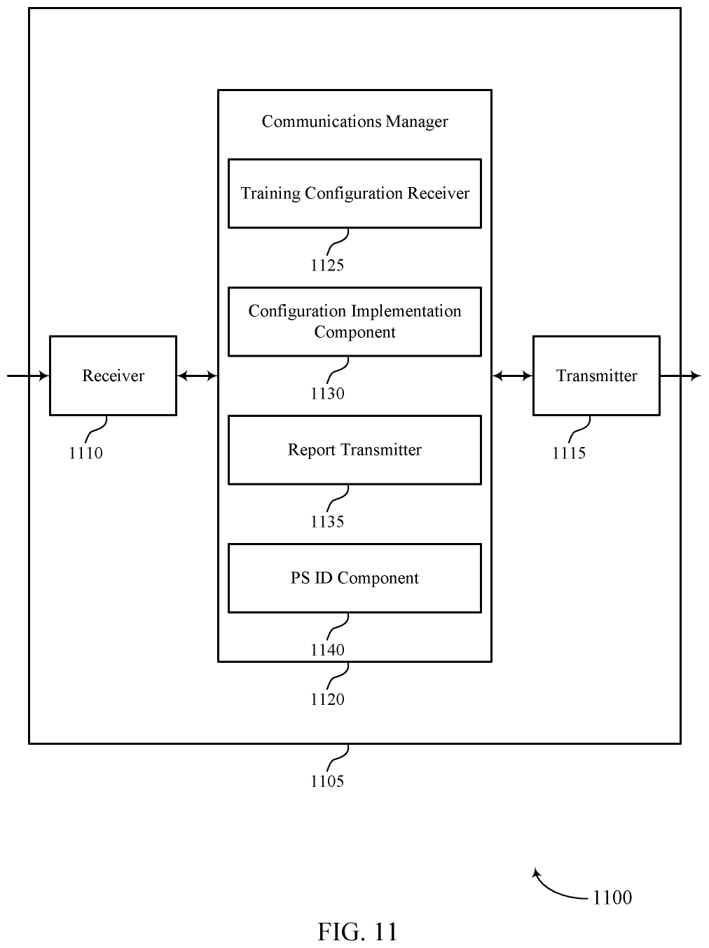

FIG. 11 shows a block diagram 1100 of a device 1105 that supports management of federated learning in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to management of federated learning). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to management of federated learning). In some examples, the transmitter 1115 may be co-located with a receiver 1110 in a transceiver unit. The transmitter 1115 may utilize a single antenna or a set of multiple antennas.

The device 1105, or various components thereof, may be an example of means for performing various aspects of management of federated learning as described herein. For example, the communications manager 1120 may include a training configuration receiver 1125, a configuration implementation component 1130, a report transmitter 1135, a PS ID component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a UE in accordance with examples as disclosed herein. The training configuration receiver 1125 may be configured as or otherwise support a means for receiving a first message indicating a training configuration for a training procedure for a predictive model, the training configuration including a set of training parameters. The configuration implementation component 1130 may be configured as or otherwise support a means for transmitting a second message indicating whether the UE has implemented the training configuration for the training procedure based on the set of training parameters.

Additionally, or alternatively, the communications manager 1120 may support wireless communications at a UE in accordance with examples as disclosed herein. The training configuration receiver 1125 may be configured as or otherwise support a means for receiving a training configuration for a training procedure associated with a predictive model, the training configuration including a first set of model parameters associated with a first PS ID. The report transmitter 1135 may be configured as or otherwise support a means for transmitting a report indicating a subset of model parameters output from the training procedure for the predictive model at the UE. The PS ID component 1140 may be configured as or otherwise support a means for receiving an indication of a second PS ID associated with a second set of model parameters based on transmitting the report, the second PS ID different from the first PS ID.

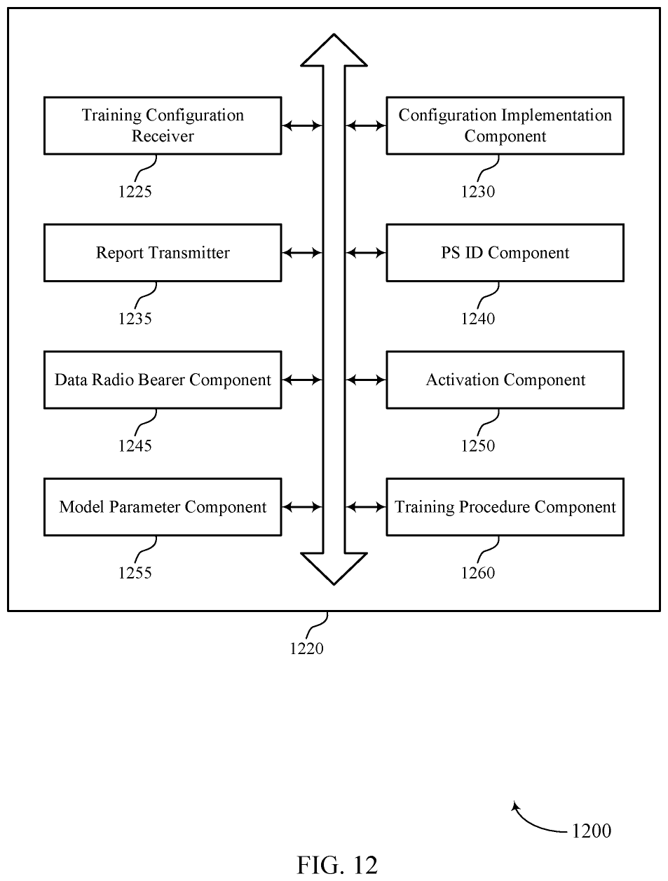

FIG. 12 shows a block diagram 1200 of a communications manager 1220 that supports management of federated learning in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of management of federated learning as described herein. For example, the communications manager 1220 may include a training configuration receiver 1225, a configuration implementation component 1230, a report transmitter 1235, a PS ID component 1240, a data radio bearer component 1245, an activation component 1250, a model parameter component 1255, a training procedure component 1260, or any combination thereof. Each of these components may communicate, directly or indirectly, with one another (e.g., via one or more buses).

The communications manager 1220 may support wireless communications at a UE in accordance with examples as disclosed herein. The training configuration receiver 1225 may be configured as or otherwise support a means for receiving a first message indicating a training configuration for a training procedure for a predictive model, the training configuration including a set of training parameters. The configuration implementation component 1230 may be configured as or otherwise support a means for transmitting a second message indicating whether the UE has implemented the training configuration for the training procedure based on the set of training parameters.

In some examples, the data radio bearer component 1245 may be configured as or otherwise support a means for receiving an indication of a data radio bearer configured for downloading a model structure and a baseline parameter set associated with the predictive model. In some examples, the data radio bearer component 1245 may be configured as or otherwise support a means for downloading the model structure and the baseline parameter set via the data radio bearer.

In some examples, the set of training parameters includes a minimum quantity of epochs for the training procedure, and the configuration implementation component 1230 may be configured as or otherwise support a means for estimating a quantity of local epochs for the training procedure based on a computational capability of the UE or a link capacity associated with the UE. In some examples, the set of training parameters includes a minimum quantity of epochs for the training procedure, and the configuration implementation component 1230 may be configured as or otherwise support a means for comparing the estimated quantity of local epochs to the minimum quantity of epochs, where the second message is transmitted based on the comparing.

In some examples, the second message indicates that the UE refrains from implementing the training configuration based on the estimated quantity of local epochs being less than the minimum quantity of epochs. In some examples, the second message indicates that the UE implements the training configuration based on the estimated quantity of local epochs being equal to or greater than the minimum quantity of epochs.

In some examples, the training procedure component 1260 may be configured as or otherwise support a means for performing the training procedure for the predictive model in accordance with the training configuration and based on the estimated quantity of local epochs. In some examples, the report transmitter 1235 may be configured as or otherwise support a means for transmitting a report indicating a set of model parameters for the predictive model based on performing the training procedure.

In some examples, the second message further includes an indication that the predictive model is ready for activation at the UE, and the activation component 1250 may be configured as or otherwise support a means for receiving a third message including an indication to activate the training procedure based on transmitting the second message, where performing the training procedure is based on receiving the third message.

In some examples, the configuration implementation component 1230 may be configured as or otherwise support a means for configuring the training procedure in accordance with the set of training parameters, where the second message further includes an indication that configuration of the training procedure is complete.

In some examples, the set of training parameters includes a MS ID associated with the predictive model, a baseline PS ID associated with the predictive model, a training validity area, a maximum quantity of epochs for the training procedure, a minimum quantity of epochs for the training procedure, a training deadline, a set of weights, a periodicity, a server address, or a combination thereof.

In some examples, the first message is received from a network node or a server.

Additionally, or alternatively, the communications manager 1220 may support wireless communications at a UE in accordance with examples as disclosed herein. In some examples, the training configuration receiver 1225 may be configured as or otherwise support a means for receiving a training configuration for a training procedure associated with a predictive model, the training configuration including a first set of model parameters associated with a first PS ID. The report transmitter 1235 may be configured as or otherwise support a means for transmitting a report indicating a subset of model parameters output from the training procedure for the predictive model at the UE. The PS ID component 1240 may be configured as or otherwise support a means for receiving an indication of a second PS ID associated with a second set of model parameters based on transmitting the report, the second PS ID different from the first PS ID.

In some examples, the activation component 1250 may be configured as or otherwise support a means for transmitting a message indicating that the predictive model is ready for activation at the UE based on receiving the indication.

In some examples, the model parameter component 1255 may be configured as or otherwise support a means for receiving a message indicating the second set of model parameters for the predictive model, the second set of model parameters including an updated set of model parameters for the predictive model.

In some examples, the training procedure component 1260 may be configured as or otherwise support a means for performing the training procedure for the predictive model using the second set of model parameters and based on the second PS ID.

In some examples, to support receiving the indication, the PS ID component 1240 may be configured as or otherwise support a means for receiving the indication from a server. In some examples, the second PS ID includes a temporary PS ID or a combination of the first PS ID and a version tag.

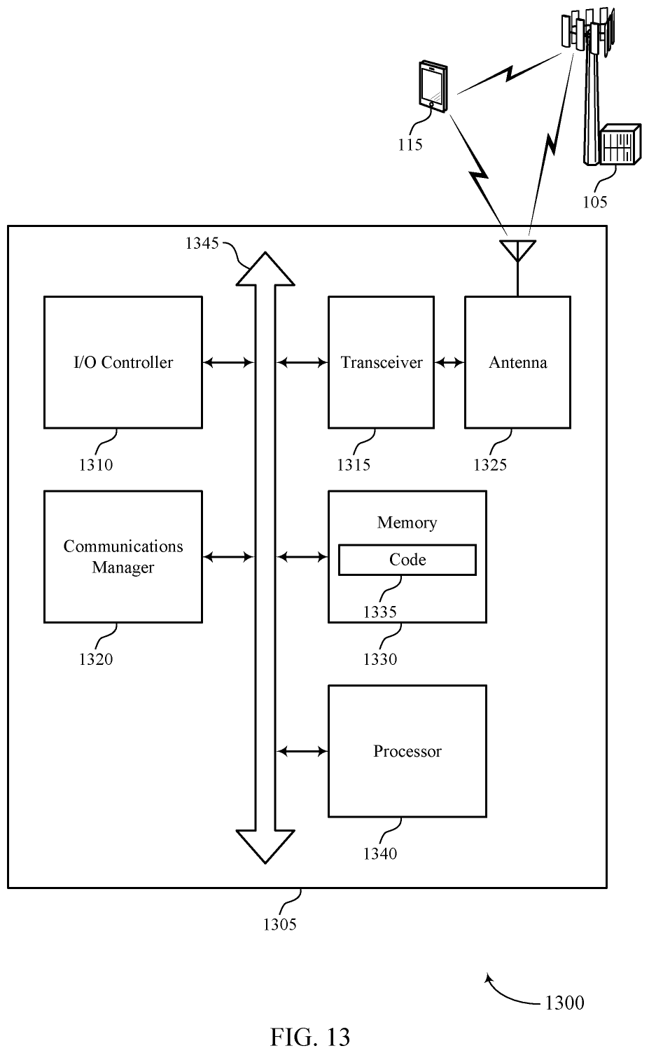

FIG. 13 shows a diagram of a system 1300 including a device 1305 that supports management of federated learning in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting management of federated learning). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communications at a UE in accordance with examples as disclosed herein. For example, the communications manager 1320 may be configured as or otherwise support a means for receiving a first message indicating a training configuration for a training procedure for a predictive model, the training configuration including a set of training parameters. The communications manager 1320 may be configured as or otherwise support a means for transmitting a second message indicating whether the UE has implemented the training configuration for the training procedure based on the set of training parameters.

Additionally, or alternatively, the communications manager 1320 may support wireless communications at a UE in accordance with examples as disclosed herein. For example, the communications manager 1320 may be configured as or otherwise support a means for receiving a training configuration for a training procedure associated with a predictive model, the training configuration including a first set of model parameters associated with a first PS ID. The communications manager 1320 may be configured as or otherwise support a means for transmitting a report indicating a subset of model parameters output from the training procedure for the predictive model at the UE. The communications manager 1320 may be configured as or otherwise support a means for receiving an indication of a second PS ID associated with a second set of model parameters based on transmitting the report, the second PS ID different from the first PS ID.

By including or configuring the communications manager 1320 in accordance with examples as described herein, the device 1305 may support techniques for efficient management of federated learning procedures. For example, the device 1305 may determine whether to participate in the FL procedure based on a capability of the device 1305, which may reduce latency, reduce signaling overhead, and improve coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof Δlthough the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of management of federated learning as described herein, or the processor 1340 and the memory 1330 may be otherwise configured to perform or support such operations.

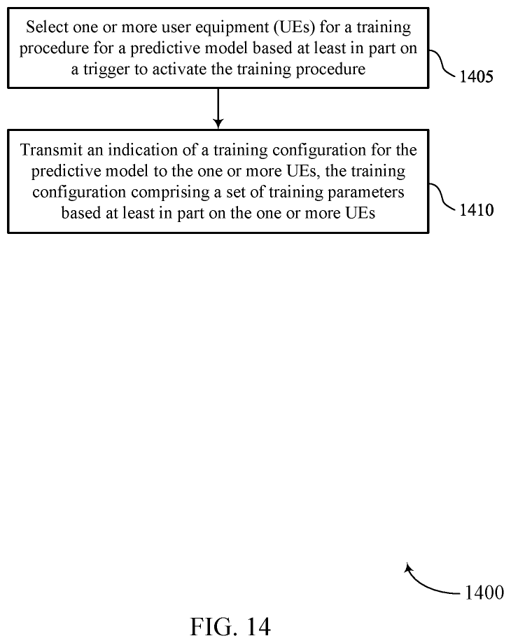

FIG. 14 shows a flowchart illustrating a method 1400 that supports management of federated learning in accordance with one or more aspects of the present disclosure. The operations of the method 1400 may be implemented by a network entity or its components as described herein. For example, the operations of the method 1400 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1405, the method may include selecting one or more user equipment (UEs) for a training procedure for a predictive model based on a trigger to activate the training procedure. The operations of 1405 may be performed in accordance with examples as disclosed herein. In some examples, aspects of the operations of 1405 may be performed by a UE selection component 825 as described with reference to FIG. 8.

At 1410, the method may include transmitting an indication of a training configuration for the predictive model to the one or more UEs, the training configuration including a set of training parameters based on the one or more UEs. The operations of 1410 may be performed in accordance with examples as disclosed herein. In some examples, aspects of the operations of 1410 may be performed by a training configuration transmitter 830 as described with reference to FIG. 8.

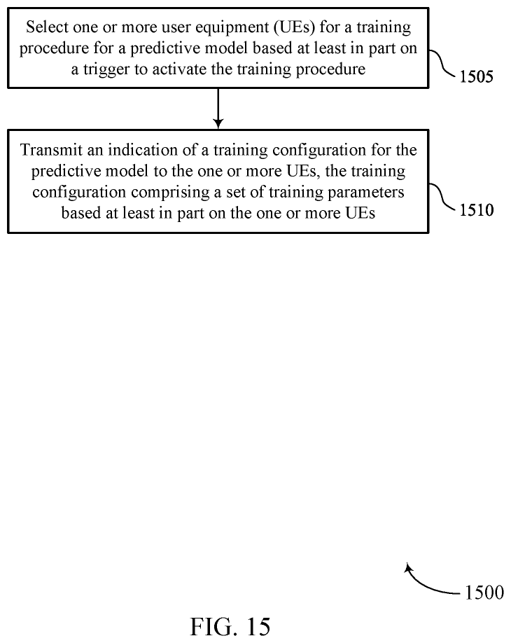

FIG. 15 shows a flowchart illustrating a method 1500 that supports management of federated learning in accordance with one or more aspects of the present disclosure. The operations of the method 1500 may be implemented by a network entity or its components as described herein. For example, the operations of the method 1500 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1505, the method may include selecting one or more user equipment (UEs) for a training procedure for a predictive model based on a trigger to activate the training procedure. The operations of 1505 may be performed in accordance with examples as disclosed herein. In some examples, aspects of the operations of 1505 may be performed by a UE selection component 825 as described with reference to FIG. 8.

At 1510, the method may include transmitting an indication of a training configuration for the predictive model to the one or more UEs, the training configuration including a set of training parameters based on the one or more UEs. The operations of 1510 may be performed in accordance with examples as disclosed herein. In some examples, aspects of the operations of 1510 may be performed by a training configuration transmitter 830 as described with reference to FIG. 8.

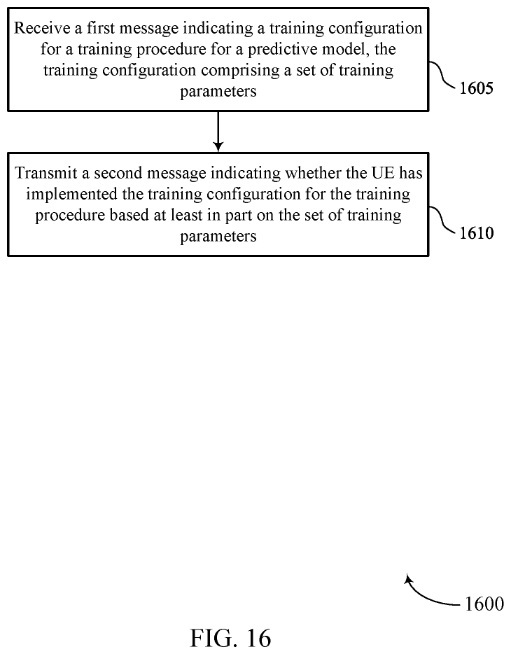

FIG. 16 shows a flowchart illustrating a method 1600 that supports management of federated learning in accordance with one or more aspects of the present disclosure. The operations of the method 1600 may be implemented by a UE or its components as described herein. For example, the operations of the method 1600 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1605, the method may include receiving a first message indicating a training configuration for a training procedure for a predictive model, the training configuration including a set of training parameters. The operations of 1605 may be performed in accordance with examples as disclosed herein. In some examples, aspects of the operations of 1605 may be performed by a training configuration receiver 1225 as described with reference to FIG. 12.

At 1610, the method may include transmitting a second message indicating whether the UE has implemented the training configuration for the training procedure based on the set of training parameters. The operations of 1610 may be performed in accordance with examples as disclosed herein. In some examples, aspects of the operations of 1610 may be performed by a configuration implementation component 1230 as described with reference to FIG. 12.

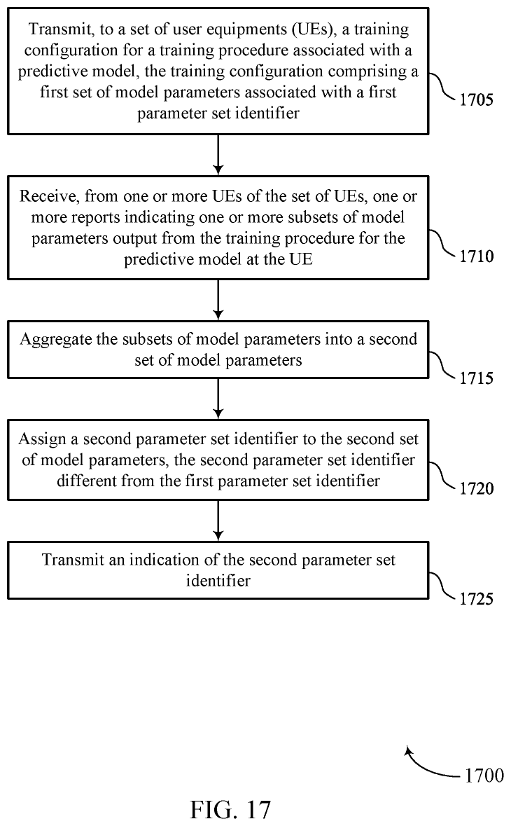

FIG. 17 shows a flowchart illustrating a method 1700 that supports management of federated learning in accordance with one or more aspects of the present disclosure. The operations of the method 1700 may be implemented by a network entity or its components as described herein. For example, the operations of the method 1700 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a set of user equipments (UEs), a training configuration for a training procedure associated with a predictive model, the training configuration including a first set of model parameters associated with a first PS ID. The operations of 1705 may be performed in accordance with examples as disclosed herein. In some examples, aspects of the operations of 1705 may be performed by a training configuration transmitter 830 as described with reference to FIG. 8.

At 1710, the method may include receiving, from one or more UEs of the set of UEs, one or more reports indicating one or more subsets of model parameters output from the training procedure for the predictive model at the UE. The operations of 1710 may be performed in accordance with examples as disclosed herein. In some examples, aspects of the operations of 1710 may be performed by a report receiver 835 as described with reference to FIG. 8.

At 1715, the method may include aggregating the subsets of model parameters into a second set of model parameters. The operations of 1715 may be performed in accordance with examples as disclosed herein. In some examples, aspects of the operations of 1715 may be performed by a model parameter component 840 as described with reference to FIG. 8.

At 1720, the method may include assigning a second PS ID to the second set of model parameters, the second PS ID different from the first PS ID. The operations of 1720 may be performed in accordance with examples as disclosed herein. In some examples, aspects of the operations of 1720 may be performed by a PS ID component 845 as described with reference to FIG. 8.

At 1725, the method may include transmitting an indication of the second PS ID. The operations of 1725 may be performed in accordance with examples as disclosed herein. In some examples, aspects of the operations of 1725 may be performed by a PS ID component 845 as described with reference to FIG. 8.

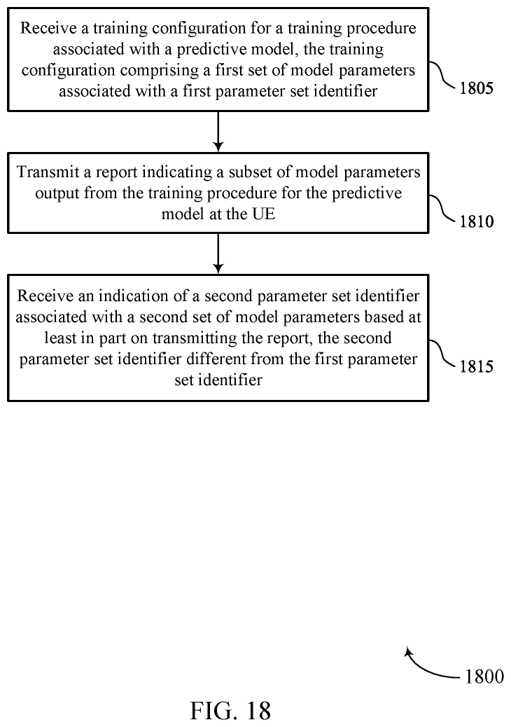

FIG. 18 shows a flowchart illustrating a method 1800 that supports management of federated learning in accordance with one or more aspects of the present disclosure. The operations of the method 1800 may be implemented by a UE or its components as described herein. For example, the operations of the method 1800 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1805, the method may include receiving a training configuration for a training procedure associated with a predictive model, the training configuration including a first set of model parameters associated with a first PS ID. The operations of 1805 may be performed in accordance with examples as disclosed herein. In some examples, aspects of the operations of 1805 may be performed by a training configuration receiver 1225 as described with reference to FIG. 12.

At 1810, the method may include transmitting a report indicating a subset of model parameters output from the training procedure for the predictive model at the UE. The operations of 1810 may be performed in accordance with examples as disclosed herein. In some examples, aspects of the operations of 1810 may be performed by a report transmitter 1235 as described with reference to FIG. 12.

At 1815, the method may include receiving an indication of a second PS ID associated with a second set of model parameters based on transmitting the report, the second PS ID different from the first PS ID. The operations of 1815 may be performed in accordance with examples as disclosed herein. In some examples, aspects of the operations of 1815 may be performed by a PS ID component 1240 as described with reference to FIG. 12.

The following provides an overview of aspects of the present disclosure:

Aspect 1: A method for wireless communications at a network node, comprising: selecting one or more UEs for a training procedure for a predictive model based at least in part on a trigger to activate the training procedure; and transmitting an indication of a training configuration for the predictive model to the one or more UEs, the training configuration comprising a set of training parameters based at least in part on the one or more UEs.

Aspect 2: The method of aspect 1, further comprising: transmitting, to a server, a first message indicating a request to activate the training procedure; and receiving, from the server, a second message indicating activation of the training procedure.

Aspect 3: The method of aspect 1, further comprising: receiving, from a server, a first message indicating that the network node is to activate the training procedure, wherein the first message comprises the trigger.

Aspect 4: The method of any of aspects 1 through 3, further comprising: transmitting, to the one or more UEs, an indication of a data radio bearer configured for downloading a model structure and a baseline parameter set associated with the predictive model.

Aspect 5: The method of any of aspects 1 through 4, further comprising: selecting the set of training parameters for the training configuration based at least in part on an estimated link capacity associated with the one or more UEs, a computational capability associated with the one or more UEs, or a combination thereof.

Aspect 6: The method of aspect 5, wherein the set of training parameters comprises a minimum quantity of epochs for the training procedure to be performed at a UE of the one or more UEs.

Aspect 7: The method of any of aspects 1 through 6, wherein the set of training parameters comprises an MS ID associated with the predictive model, a baseline PS ID associated with the predictive model, a training validity area, a maximum quantity of epochs for the training procedure, a minimum quantity of epochs for the training procedure, a training deadline, a set of weights, a periodicity, a server address, or a combination thereof.

Aspect 8: The method of any of aspects 1 through 7, further comprising: receiving, from at least one UE of the one or more UEs, a message indicating that the at least one UE has implemented the training configuration.

Aspect 9: The method of any of aspects 1 through 7, further comprising: receiving, from at least one UE of the one or more UEs, a message indicating that the at least one UE has refrained from implementing the training configuration.

Aspect 10: The method of any of aspects 1 through 8, further comprising: receiving, from at least one UE of the one or more UEs, a message indicating that the predictive model is ready for activation at the at least one UE.

Aspect 11: The method of any of aspects 1 through 10, further comprising: transmitting, to the one or more UEs, a message comprising an indication to activate the training procedure at the one or more UEs.

Aspect 12: A method for wireless communications at a server, comprising: selecting one or more UEs for a training procedure for a predictive model based at least in part on a trigger to activate the training procedure; and transmitting an indication of a training configuration for the predictive model to the one or more UEs, the training configuration comprising a set of training parameters based at least in part on the one or more UEs.

Aspect 13: The method of aspect 12, further comprising: receiving, from a network node, a message indicating a request to activate the training procedure, wherein the indication of the training configuration is transmitted based at least in part on receiving the message.

Aspect 14: The method of any of aspects 12 through 13, further comprising: transmitting, to a network node, a message indicating that the network node is to activate the training procedure, wherein the message comprises the trigger.

Aspect 15: The method of any of aspects 12 through 14, further comprising: transmitting, to the one or more UEs, an indication of a data radio bearer configured for downloading a model structure and a baseline parameter set associated with the predictive model.

Aspect 16: The method of any of aspects 12 through 15, further comprising: selecting the set of training parameters for the training configuration based at least in part on an estimated link capacity associated with the one or more UEs, a computational capability associated with the one or more UEs, or a combination thereof.

Aspect 17: The method of aspect 16, wherein the set of training parameters comprises a minimum quantity of epochs for the training procedure to be performed at a UE of the one or more UEs.

Aspect 18: The method of any of aspects 12 through 17, wherein the set of training parameters comprises an MS ID associated with the predictive model, a baseline PS ID associated with the predictive model, a training validity area, a maximum quantity of epochs for the training procedure, a minimum quantity of epochs for the training procedure, a training deadline, a set of weights, a periodicity, a server address, or a combination thereof.

Aspect 19: A method for wireless communications at a UE, comprising: receiving a first message indicating a training configuration for a training procedure for a predictive model, the training configuration comprising a set of training parameters; and transmitting a second message indicating whether the UE has implemented the training configuration for the training procedure based at least in part on the set of training parameters.

Aspect 20: The method of aspect 19, further comprising: receiving an indication of a data radio bearer configured for downloading a model structure and a baseline parameter set associated with the predictive model; and downloading the model structure and the baseline parameter set via the data radio bearer.

Aspect 21: The method of any of aspects 19 through 20, wherein the set of training parameters comprises a minimum quantity of epochs for the training procedure, the method further comprising: estimating a quantity of local epochs for the training procedure based at least in part on a computational capability of the UE or a link capacity associated with the UE; and comparing the estimated quantity of local epochs to the minimum quantity of epochs, wherein the second message is transmitted based at least in part on the comparing.

Aspect 22: The method of aspect 21, wherein the second message indicates that the UE refrains from implementing the training configuration based at least in part on the estimated quantity of local epochs being less than the minimum quantity of epochs.

Aspect 23: The method of aspect 21, wherein the second message indicates that the UE implements the training configuration based at least in part on the estimated quantity of local epochs being equal to or greater than the minimum quantity of epochs.

Aspect 24: The method of aspect 23, further comprising: performing the training procedure for the predictive model in accordance with the training configuration and based at least in part on the estimated quantity of local epochs; and transmitting a report indicating a set of model parameters for the predictive model based at least in part on performing the training procedure.

Aspect 25: The method of aspect 24, wherein the second message further comprises an indication that the predictive model is ready for activation at the UE, the method further comprising: receiving a third message comprising an indication to activate the training procedure based at least in part on transmitting the second message, wherein performing the training procedure is based at least in part on receiving the third message.

Aspect 26: The method of any of aspects 19 through 25, further comprising: configuring the training procedure in accordance with the set of training parameters, wherein the second message further comprises an indication that configuration of the training procedure is complete.

Aspect 27: The method of any of aspects 19 through 26, wherein the set of training parameters comprises an MS ID associated with the predictive model, a baseline PS ID associated with the predictive model, a training validity area, a maximum quantity of epochs for the training procedure, a minimum quantity of epochs for the training procedure, a training deadline, a set of weights, a periodicity, a server address, or a combination thereof.

Aspect 28: The method of any of aspects 19 through 27, wherein the first message is received from a network node or a server.

Aspect 29: A method for wireless communications at a server, comprising: transmitting, to a set of UEs, a training configuration for a training procedure associated with a predictive model, the training configuration comprising a first set of model parameters associated with a first PS ID; receiving, from one or more UEs of the set of UEs, one or more reports indicating one or more subsets of model parameters output from the training procedure for the predictive model at the UE; aggregating the subsets of model parameters into a second set of model parameters; assigning a second PS ID to the second set of model parameters, the second PS ID different from the first PS ID; and transmitting an indication of the second PS ID.

Aspect 30: The method of aspect 29, further comprising: receiving, from at least one UE of the set of UEs, a message indicating that the predictive model is ready for activation at the UE based at least in part on transmitting the indication.

Aspect 31: The method of any of aspects 29 through 30, further comprising: transmitting, to the set of UEs, a message indicating the second set of model parameters for the predictive model, the second set of model parameters comprising an updated set of model parameters for the predictive model.

Aspect 32: The method of any of aspects 29 through 31, wherein transmitting the indication comprises: transmitting the indication to a network node, to the set of UEs, or both.

Aspect 33: The method of any of aspects 29 through 32, wherein the second PS ID comprises a temporary PS ID or a combination of the first PS ID and a version tag.

Aspect 34: A method for wireless communications at a UE, comprising: receiving a training configuration for a training procedure associated with a predictive model, the training configuration comprising a first set of model parameters associated with a first PS ID; transmitting a report indicating a subset of model parameters output from the training procedure for the predictive model at the UE; and receiving an indication of a second PS ID associated with a second set of model parameters based at least in part on transmitting the report, the second PS ID different from the first PS ID.

Aspect 35: The method of aspect 34, further comprising: transmitting a message indicating that the predictive model is ready for activation at the UE based at least in part on receiving the indication.

Aspect 36: The method of any of aspects 34 through 35, further comprising: receiving a message indicating the second set of model parameters for the predictive model, the second set of model parameters comprising an updated set of model parameters for the predictive model.

Aspect 37: The method of aspect 36, further comprising: performing the training procedure for the predictive model using the second set of model parameters and based at least in part on the second PS ID.

Aspect 38: The method of any of aspects 34 through 37, wherein receiving the indication comprises: receiving the indication from a server.

Aspect 39: The method of any of aspects 34 through 38, wherein the second PS ID comprises a temporary PS ID or a combination of the first PS ID and a version tag.

Aspect 40: An apparatus for wireless communications at a network node, comprising a processor; memory coupled with the processor; and instructions stored in the memory and executable by the processor to cause the apparatus to perform a method of any of aspects 1 through 11.

Aspect 41: An apparatus for wireless communications at a network node, comprising at least one means for performing a method of any of aspects 1 through 11.

Aspect 42: A non-transitory computer-readable medium storing code for wireless communications at a network node, the code comprising instructions executable by a processor to perform a method of any of aspects 1 through 11.

Aspect 43: An apparatus for wireless communications at a server, comprising a processor; memory coupled with the processor; and instructions stored in the memory and executable by the processor to cause the apparatus to perform a method of any of aspects 12 through 18.

Aspect 44: An apparatus for wireless communications at a server, comprising at least one means for performing a method of any of aspects 12 through 18.

Aspect 45: A non-transitory computer-readable medium storing code for wireless communications at a server, the code comprising instructions executable by a processor to perform a method of any of aspects 12 through 18.

Aspect 46: An apparatus for wireless communications at a UE, comprising a processor; memory coupled with the processor; and instructions stored in the memory and executable by the processor to cause the apparatus to perform a method of any of aspects 19 through 28.

Aspect 47: An apparatus for wireless communications at a UE, comprising at least one means for performing a method of any of aspects 19 through 28.

Aspect 48: A non-transitory computer-readable medium storing code for wireless communications at a UE, the code comprising instructions executable by a processor to perform a method of any of aspects 19 through 28.

Aspect 49: An apparatus for wireless communications at a server, comprising a processor; memory coupled with the processor; and instructions stored in the memory and executable by the processor to cause the apparatus to perform a method of any of aspects 29 through 33.

Aspect 50: An apparatus for wireless communications at a server, comprising at least one means for performing a method of any of aspects 29 through 33.

Aspect 51: A non-transitory computer-readable medium storing code for wireless communications at a server, the code comprising instructions executable by a processor to perform a method of any of aspects 29 through 33.

Aspect 52: An apparatus for wireless communications at a UE, comprising a processor; memory coupled with the processor; and instructions stored in the memory and executable by the processor to cause the apparatus to perform a method of any of aspects 34 through 39.

Aspect 53: An apparatus for wireless communications at a UE, comprising at least one means for performing a method of any of aspects 34 through 39.

Aspect 54: A non-transitory computer-readable medium storing code for wireless communications at a UE, the code comprising instructions executable by a processor to perform a method of any of aspects 34 through 39.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a network node, comprising:
selecting one or more user equipment (UEs) for a training procedure for a predictive model based at least in part on a trigger to activate the training procedure; and
transmitting an indication of a training configuration for the predictive model to the one or more UEs, the training configuration comprising a set of training parameters based at least in part on the one or more UEs.

2. The method of claim 1, further comprising:
transmitting, to the one or more UEs, an indication of a data radio bearer configured for downloading a model structure and a baseline parameter set associated with the predictive model.

3. The method of claim 1, further comprising:
selecting the set of training parameters for the training configuration based at least in part on an estimated link capacity associated with the one or more UEs, a computational capability associated with the one or more UEs, or a combination thereof.

4. The method of claim 3, wherein the set of training parameters comprises a minimum quantity of epochs for the training procedure to be performed at a UE of the one or more UEs.

5. The method of claim 1, wherein the set of training parameters comprises a model structure identifier associated with the predictive model, a baseline parameter set identifier associated with the predictive model, a training validity area, a maximum quantity of epochs for the training procedure, a minimum quantity of epochs for the training procedure, a training deadline, a set of weights, a periodicity, a server address, or a combination thereof.

6. The method of claim 1, further comprising:
receiving, from at least one UE of the one or more UEs, a message indicating that the at least one UE has implemented the training configuration or indicating that the at least one UE has refrained from implementing the training configuration.

7. The method of claim 1, further comprising:
receiving, from at least one UE of the one or more UEs, a message indicating that the predictive model is ready for activation at the at least one UE.

8. The method of claim 1, further comprising:
transmitting, to the one or more UEs, a message comprising an indication to activate the training procedure at the one or more UEs.

9. A method for wireless communications at a server, comprising:
selecting one or more user equipment (UEs) for a training procedure for a predictive model based at least in part on a trigger to activate the training procedure; and
transmitting an indication of a training configuration for the predictive model to the one or more UEs, the training configuration comprising a set of training parameters based at least in part on the one or more UEs.

10. The method of claim 9, further comprising:
transmitting, to the one or more UEs, an indication of a data radio bearer configured for downloading a model structure and a baseline parameter set associated with the predictive model.

11. The method of claim 9, further comprising:
selecting the set of training parameters for the training configuration based at least in part on an estimated link capacity associated with the one or more UEs, a computational capability associated with the one or more UEs, or a combination thereof, wherein the set of training parameters comprises a minimum quantity of epochs for the training procedure to be performed at a UE of the one or more UEs.

12. The method of claim 9, wherein the set of training parameters comprises a model structure identifier associated with the predictive model, a baseline parameter set identifier associated with the predictive model, a training validity area, a maximum quantity of epochs for the training procedure, a minimum quantity of epochs for the training procedure, a training deadline, a set of weights, a periodicity, a server address, or a combination thereof.

13. A method for wireless communications at a user equipment (UE), comprising:
receiving a first message indicating a training configuration for a training procedure for a predictive model, the training configuration comprising a set of training parameters; and
transmitting a second message indicating whether the UE has implemented the training configuration for the training procedure based at least in part on the set of training parameters.

14. The method of claim 13, further comprising:
receiving an indication of a data radio bearer configured for downloading a model structure and a baseline parameter set associated with the predictive model; and
downloading the model structure and the baseline parameter set via the data radio bearer.

15. The method of claim 13, wherein the set of training parameters comprises a minimum quantity of epochs for the training procedure, the method further comprising:
estimating a quantity of local epochs for the training procedure based at least in part on a computational capability of the UE or a link capacity associated with the UE; and
comparing the estimated quantity of local epochs to the minimum quantity of epochs, wherein the second message is transmitted based at least in part on the comparing.

16. The method of claim 15, wherein the second message indicates that the UE refrains from implementing the training configuration based at least in part on the estimated quantity of local epochs being less than the minimum quantity of epochs.

17. The method of claim 15, wherein the second message indicates that the UE implements the training configuration based at least in part on the estimated quantity of local epochs being equal to or greater than the minimum quantity of epochs.

18. The method of claim 17, further comprising:
performing the training procedure for the predictive model in accordance with the training configuration and based at least in part on the estimated quantity of local epochs; and
transmitting a report indicating a set of model parameters for the predictive model based at least in part on performing the training procedure.

19. The method of claim 18, wherein the second message further comprises an indication that the predictive model is ready for activation at the UE, the method further comprising:
receiving a third message comprising an indication to activate the training procedure based at least in part on transmitting the second message, wherein performing the training procedure is based at least in part on receiving the third message.

20. The method of claim 13, further comprising:
configuring the training procedure in accordance with the set of training parameters, wherein the second message further comprises an indication that configuration of the training procedure is complete.

21. The method of claim 13, wherein the set of training parameters comprises a model structure identifier associated with the predictive model, a baseline parameter set identifier associated with the predictive model, a training validity area, a maximum quantity of epochs for the training procedure, a minimum quantity of epochs for the training procedure, a training deadline, a set of weights, a periodicity, a server address, or a combination thereof.

22. A method for wireless communications at a server, comprising:
transmitting, to a set of user equipments (UEs), a training configuration for a training procedure associated with a predictive model, the training configuration comprising a first set of model parameters associated with a first parameter set identifier;
receiving, from one or more UEs of the set of UEs, one or more reports indicating one or more subsets of model parameters output from the training procedure for the predictive model at the UE;
aggregating the subsets of model parameters into a second set of model parameters;
assigning a second parameter set identifier to the second set of model parameters, the second parameter set identifier different from the first parameter set identifier; and
transmitting an indication of the second parameter set identifier.

23. The method of claim 22, further comprising:
receiving, from at least one UE of the set of UEs, a message indicating that the predictive model is ready for activation at the UE based at least in part on transmitting the indication.

24. The method of claim 22, further comprising:
transmitting, to the set of UEs, a message indicating the second set of model parameters for the predictive model, the second set of model parameters comprising an updated set of model parameters for the predictive model.

25. The method of claim 22, wherein the second parameter set identifier comprises a temporary parameter set identifier or a combination of the first parameter set identifier and a version tag.

26. A method for wireless communications at a user equipment (UE), comprising:
receiving a training configuration for a training procedure associated with a predictive model, the training configuration comprising a first set of model parameters associated with a first parameter set identifier;
transmitting a report indicating a subset of model parameters output from the training procedure for the predictive model at the UE; and
receiving an indication of a second parameter set identifier associated with a second set of model parameters based at least in part on transmitting the report, the second parameter set identifier different from the first parameter set identifier.

27. The method of claim 26, further comprising:
transmitting a message indicating that the predictive model is ready for activation at the UE based at least in part on receiving the indication.

28. The method of claim 26, further comprising:
receiving a message indicating the second set of model parameters for the predictive model, the second set of model parameters comprising an updated set of model parameters for the predictive model.

29. The method of claim 28, further comprising:
performing the training procedure for the predictive model using the second set of model parameters and based at least in part on the second parameter set identifier.

30. The method of claim 26, wherein the second parameter set identifier comprises a temporary parameter set identifier or a combination of the first parameter set identifier and a version tag.
